(19) United States
(12) Patent Application Publication
(10) Pub. No.: US 2025/0139631 A1
(43) Pub. Date: May 1, 2025

(54) UTILIZING A DIGITAL DIRECT DEPOSIT PREDICTOR MACHINE-LEARNING MODEL TO DETERMINE RISK FOR A NETWORK TRANSACTION COMPRISING A DIGITAL DIRECT DEPOSIT ADVANCE

(71) Applicant: Chime Financial, Inc., San Francisco, CA (US)

(72) Inventor: Jigar Mehta, Milpitas, CA (US)

(21) Appl. No.: 18/498,719

(22) Filed: Oct. 31, 2023

(51) Int. Cl. G06Q 20/40; G06Q 20/38

(52) U.S. Cl. CPC G06Q 20/4016; G06Q 20/389

(57) ABSTRACT

The present disclosure relates to systems, non-transitory computer-readable media, and methods for utilizing a digital direct deposit predictor machine-learning model to generate a digital direct deposit likelihood and processing a network transaction based on the digital direct deposit likelihood. In particular, in one or more embodiments, the disclosed systems generate a risk classification based on the digital direct deposit likelihood and utilize the risk classification to process the network transaction. Moreover, in one or more embodiments, the disclosed systems generate a digital direct deposit amount based on the digital direct deposit likelihood and/or the risk classification and process the network transaction accordingly. Moreover, the disclosed systems can display information related to network transactions in a digital direct deposit interface.

### BACKGROUND

Recent years have seen significant improvements in transaction management systems that utilize web-based and mobile-based applications to manage digital information for user accounts. Conventional systems can facilitate digital direct deposits in order to allow access to digital direct deposit transactions outside of traditional or anticipated digital direct deposit timing by offering an option to request an advance on a digital direct deposit. For example, conventional systems implement rules-based or heuristic methods to determine or facilitate a digital direct deposit advance or, in some cases, simply offer a fixed digital direct deposit advance amount for all or a portion of a digital direct deposit advance request. Although conventional systems can offer digital direct deposit advances, conventional systems face a number of technical shortcomings, particularly with regard to inaccurate, inefficient, and inaccurate methods of determining the risk involved in providing digital direct deposit advances.

For example, conventional systems often cannot accurately predict whether a user account will receive a digital direct deposit after providing a digital direct deposit advance. More specifically, conventional systems underestimate the risk involved in digital direct deposit advance requests because the rules-based or heuristic methods that conventional systems rely on for determining digital direct deposit advance amounts miss crucial constraints or fail to incorporate the vast amount of constantly changing variables needed for making accurate determinations. In such cases, conventional systems provide a digital direct deposit advance, but a user account associated with the digital direct deposit advance fails to receive a digital direct deposit to cover the amount of the digital direct deposit.

Additionally, due to the rules-based or heuristic methods and/or simply offering a fixed digital direct deposit amount, conventional systems are inflexible in that they are limited to the defined rules, guidelines, or heuristics that incorporate only some types of data for determining digital direct deposit amounts. In particular, conventional systems cannot robustly (or flexibly) transform data from a variety of sources to provide insights into the risk associated with a request for a digital direct deposit advance. Rather, many conventional systems utilize or enable access to only historical deposit transaction data for a user account.

Moreover, conventional systems often inefficiently utilize computational resources due to excessive navigation between user interfaces for requesting and displaying information pertaining to digital direct deposit advances. Because conventional systems rely on and/or only have access to historical deposit transaction data, and therefore lack information needed to determine whether or not to provide the digital direct deposit advance, conventional systems often utilize multiple user interfaces to gather data and/or information pertaining to digital direct deposit advances. For example, conventional systems utilize multiple interfaces, each requiring user interaction or user input, to gather necessary information or to determine how important some information is to the digital direct deposit advance. These, along with additional problems and issues, exist with regard to conventional systems.

### BRIEF SUMMARY

Embodiments of the present disclosure provide benefits and/or solve one or more of the foregoing or other problems in the art with systems, non-transitory computer-readable media, and methods that utilize a digital direct deposit predictor machine-learning model to generate digital direct deposit likelihoods and utilize the digital direct deposit likelihood to intelligently processing network transaction requests comprising digital direct deposit advance requests. For example, the disclosed systems can receive a request to initiate a network transaction comprising a digital direct deposit advance request and identify features of the network transaction. The disclosed systems can then utilize a digital direct deposit predictor machine-learning model to generate a digital direct deposit likelihood based on the identified features and process the network transaction based on the digital direct deposit likelihood. In one or more embodiments, the disclosed system utilizes an assembler to assign a risk segment for the network transaction based on the digital direct deposit likelihood and additional user account data, then utilizes the risk classification to process the network transaction. Additional features and advantages of one or more embodiments of the present disclosure are outlined in the description which follows and, in part, will be obvious from the description or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a digital direct deposit advance risk analysis system can operate in accordance with one or more embodiments.

FIG. 2 illustrates an overview of a digital direct deposit advance risk analysis system utilizing a digital direct deposit predictor machine-learning model to process a network transaction in accordance with one or more embodiments.

FIGS. 3A-3C illustrate the digital direct deposit advance risk analysis system utilizing and training a digital direct deposit predictor machine-learning model to generate digital direct deposit likelihoods in accordance with one or more embodiments.

FIG. 4 illustrates the digital direct deposit advance risk analysis system utilizing a risk analysis assembler to generate a risk classification in accordance with one or more embodiments.

FIG. 5 illustrates processing a network transaction in accordance with one or more embodiments.

FIGS. 6A-6C illustrate example graphical user interfaces for initiating a network transaction and displaying information related to processed network transactions in accordance with one or more embodiments.

FIGS. 7A-7B illustrate example graphical user interfaces for displaying information related to digital direct deposits received after a digital direct deposit advance in accordance with one or more embodiments.

FIG. 8 illustrates a graph depicting precision, recall, specificity, and other metrics denoting the accuracy of the digital direct deposit advance risk analysis system in accordance with one or more embodiments.

FIG. 9 illustrates an example graph depicting accurately labeled network transactions denoting the accuracy of the digital direct deposit advance risk analysis system in accordance with one or more embodiments.

FIG. 10 illustrates an example series of acts for utilizing a digital direct deposit predictor machine-learning model to generate a digital direct deposit likelihood in accordance with one or more embodiments.

FIG. 11 illustrates a block diagram of a computing device for implementing one or more embodiments of the present disclosure.

FIG. 12 illustrates an example environment for an inter-network facilitation system in accordance with one or more embodiments.

### DETAILED DESCRIPTION

This disclosure describes one or more embodiments of a digital direct deposit advance risk analysis system that utilizes a digital direct deposit predictor machine-learning model to generate a digital direct deposit likelihood and uses the digital direct deposit likelihood to process digital direct deposit advance requests. In particular, the digital direct deposit advance risk analysis system can receive a request to initiate a network transaction that comprises a request for a digital direct deposit advance. The digital direct deposit advance risk analysis system can analyze the network transaction to identify features and utilize the digital direct deposit predictor machine-learning model to generate digital direct deposit likelihoods that accurately predict whether a user account associated with the network transaction will receive a future digital direct deposit. Further, the digital direct deposit advance risk analysis system can process the network transaction according to the digital direct deposit likelihood.

As just mentioned, in one or more embodiments, the digital direct deposit advance risk analysis system identifies features associated with the network transaction. For example, the digital direct deposit advance risk analysis system can analyze a network transaction (and associated applications or data sources) to identify features. In some cases, the digital direct deposit advance risk analysis system identifies features by identifying historical digital direct deposit features, user account features, check deposit features, application activity features, check deposit features, account balance features, physical card features, peer-to-peer transaction features, customer service ticket features, or time elapsed features.

As mentioned, the digital direct deposit advance risk analysis system can utilize a digital direct deposit predictor machine-learning model to generate a digital direct deposit likelihood. In one or more embodiments, the digital direct deposit advance risk analysis system generates a training dataset to train the digital direct deposit predictor machine-learning model to generate accurate digital direct deposit likelihoods. For example, the digital direct deposit advance risk analysis system generates the training dataset by sampling training features that correspond to digital direct deposit advance requests associated with user accounts that received previous digital direct deposits.

In one or more embodiments, the digital direct deposit advance risk analysis system further processes digital direct deposit likelihoods by utilizing a risk analysis assembler to generate risk classifications from digital direct deposit likelihoods. For example, the risk analysis assembler can utilize digital direct deposit likelihoods, user account data (e.g., historical account data, historical employment data, employer data, and other data), and, in some cases, deposit transaction predictions (e.g., predicting the timing or amount of a future digital direct deposit) to generate a risk classification for the network transaction. In some cases, the risk classification can correspond to a metric or decile that indicates whether or not a user account associated with the network transaction will receive a future digital direct deposit.

Moreover, in one or more embodiments, the digital direct deposit advance risk analysis system uses the digital direct deposit likelihood and/or risk classification to process network transactions. In particular, the digital direct deposit advance risk analysis system can use the digital direct deposit likelihood to deny the network transaction or to approve the network transaction by determining a digital direct deposit advance amount for the transaction. For instance, the digital direct deposit advance risk analysis system can identify that a risk classification for the network transaction corresponds to an allowed advance percent of an average digital direct deposit amount for a user account associated with the network transaction and determine the digital direct deposit amount based on the allowed advance percent and the average digital direct deposit amount. In some cases, the digital direct deposit advance risk analysis system identifies that the digital direct deposit amount exceeds an allowed amount (e.g., because of regulations around digital direct deposit limits or other credit extended to the user account) and determines a digital direct deposit amount based on comparing the digital direct deposit amount to an allowed digital direct deposit amount.

The digital direct deposit advance risk analysis system provides a variety of technical advantages, benefits, and practical applications to relative conventional systems. For example, in contrast to conventional systems that fail to accurately predict whether a user account will receive a digital direct deposit after providing a digital direct deposit advance, the digital direct deposit advance risk analysis system utilizes a trained digital direct deposit predictor machine-learning model to generate digital direct deposit likelihoods. Moreover, the digital direct deposit advance risk analysis system utilizes a risk analysis assembler that incorporates additional account data along with the digital direct deposit likelihood with other account data to accurately predict the likelihood of whether a user account will receive a digital direct deposit. Indeed, through this multi-modal approach, the digital direct deposit advance risk analysis system can accurately identify fraudulent, uncertain, or risky network transactions even if only relatively few data points are known.

In contrast to conventional systems that use rules-based or heuristic methods utilizing only historical deposit transaction data, the digital direct deposit advance risk analysis system can identify and flexibly incorporate various features from a network transaction to generate a digital direct deposit likelihood and/or a risk classification. By using a multi-modal approach that can identify the relative importance of features from a network transaction and incorporate them into generating digital direct deposit likelihoods, the digital direct deposit advance risk system can use unique combinations of features. Indeed, the digital direct deposit advance risk analysis system can receive (or identify) data from multiple sources that may factor into the digital direct deposit likelihood within the digital direct deposit predictor machine-learning model (e.g., resulting in digital direct deposit likelihoods with improved accuracy).

Furthermore, unlike conventional systems that require excessive navigation between user interfaces to gather information before providing a digital direct deposit advance, the digital direct deposit advance risk analysis system requires only minimal user interface interactions in order to identify network transactions that will result in providing a digital direct deposit advance without receiving a digital direct deposit. By utilizing a digital direct deposit predictor machine-learning model trained to generate digital direct deposit likelihoods from even relatively few features, the digital direct deposit advance risk analysis system requires no additional data input outside of a request to initiate the network transaction (e.g., through selection of an option or an input of a requested digital direct deposit advance amount).

As illustrated by the foregoing discussion, the present disclosure utilizes a variety of terms to describe features and advantages of the digital direct deposit advance risk analysis system. Additional detail is now provided regarding the meaning of such terms. For example, as used herein, the term “network transaction” refers to a transaction performed as part of an exchange of tokens, currency, or data between accounts or other connections of the system. In some embodiments, the network transaction may be a request to transfer tokens, currency, or data into an account associated with the network transaction. In other embodiments, the network transaction may be a deposit of tokens, currency, or data into an account (e.g., as a paycheck).

In addition, as used herein, the term “digital direct deposit” refers to an electronic deposit of tokens, currency, or data directly into an account. In particular, the term digital direct deposit can include an electronic deposit provided in exchange for goods and/or services (e.g., a paycheck) or as a stipend. To illustrate, a digital direct deposit can include deposits of earned income (e.g., salaries or hourly wage income), pensions, or government payments. Moreover, as used herein, the term “digital direct deposit advance” refers to an electronic deposit of tokens, currency, or data in anticipation of a future digital direct deposit. For example, a digital direct deposit advance can include a deposit that will credit an account prior to the deposit of a digital direct deposit. To illustrate, a digital direct deposit advance can comprise a percentage of an anticipated digital direct deposit, a set amount, or an amount based on the risk associated with proving the digital direct deposit advance.

As used herein, the term “machine-learning model” refers to a computer algorithm or a collection of computer algorithms that automatically improve for a particular task through experience based on the use of data. For example, a machine-learning model can utilize one or more learning techniques to improve accuracy and/or effectiveness. Example machine-learning models include various types of decision trees, support vector machines, Bayesian networks, or neural networks.

As mentioned, in some embodiments, the digital direct deposit predictor machine-learning model can be a neural network. The term “neural network” refers to a machine-learning model that can be trained and/or tuned based on inputs to determine classifications or approximate unknown functions. For example, a neural network includes a model of interconnected artificial neurons (e.g., organized in layers) that communicate and learn to approximate complex functions and generate outputs (e.g., generated digital images) based on a plurality of inputs provided to the neural network. In some cases, a neural network refers to an algorithm (or set of algorithms) that implements deep learning techniques to model high-level abstractions in data. For example, a neural network can include a convolutional neural network, a recurrent neural network (e.g., an LSTM), a graph neural network, a self-attention transformer neural network, or a generative adversarial neural network.

In some cases, the machine-learning model comprises a digital direct deposit predictor machine-learning model. As used herein, the term “digital direct deposit predictor machine-learning model” refers to a machine-learning model trained or used to predict whether a user account will receive a future digital direct deposit. In some cases, the digital direct deposit predictor machine-learning model refers to a trained machine-learning model that generates a digital direct deposit likelihood or digital direct deposit classification for a network transaction comprising a digital direct deposit advance request. For example, the digital direct deposit predictor machine-learning can utilize a series of gradient-boosted decision trees (e.g., XGBoost algorithm), while in other cases, the digital direct deposit predictor machine-learning model is a random forest model, a multilayer perceptron, a linear regression, a support vector machine, a deep tabular learning architecture, a deep learning transformer (e.g., self-attention-based-tabular transformer), or a logistic regression.

Further, as used herein, the term “digital direct deposit likelihood” refers to refers to a metric, classification, or probability that a user account will receive a digital direct deposit. For example, a digital direct deposit likelihood can numerically express the likelihood that a user account will receive a digital direct deposit based on features or indicators present in the network transaction. To illustrate, a digital direct deposit predictor machine-learning model can generate a digital direct deposit likelihood from features identified from a network transaction comprising a digital direct deposit advance request.

Also, as used herein, the term “risk analysis assembler” refers to a system, process, or other computer code that can assemble, aggregate, or process data to generate a risk classification. In particular, the term risk analysis assembler can utilize conditional statements or conditional expressions to enable the execution of specific code or logic to generate a risk classification. To illustrate, a risk analysis assembler can utilize conditional statements or expressions to generate a risk classification for a network transaction based on network transaction information, a digital direct deposit likelihood, and/or user account data.

Moreover, as used herein, the term “risk classification” refers to a classification, metric, or label indicating whether a user account associated with a network transaction will receive a future digital direct deposit. In particular, the term risk classification can comprise a score (e.g., a number, a fraction, or other numerical indicators) indicating a degree to which a risk analysis assembler predicts a user account will or will not receive a future digital direct deposit. In other embodiments, a risk classification can be a label or identifier associated with a score, metric, ranking, group, or decile of scores that indicate whether a user account will or will not receive a future digital direct deposit. To illustrate, a risk classifier can be “very high risk,” “high risk,” “medium risk,” “low risk,” or “very low risk.”

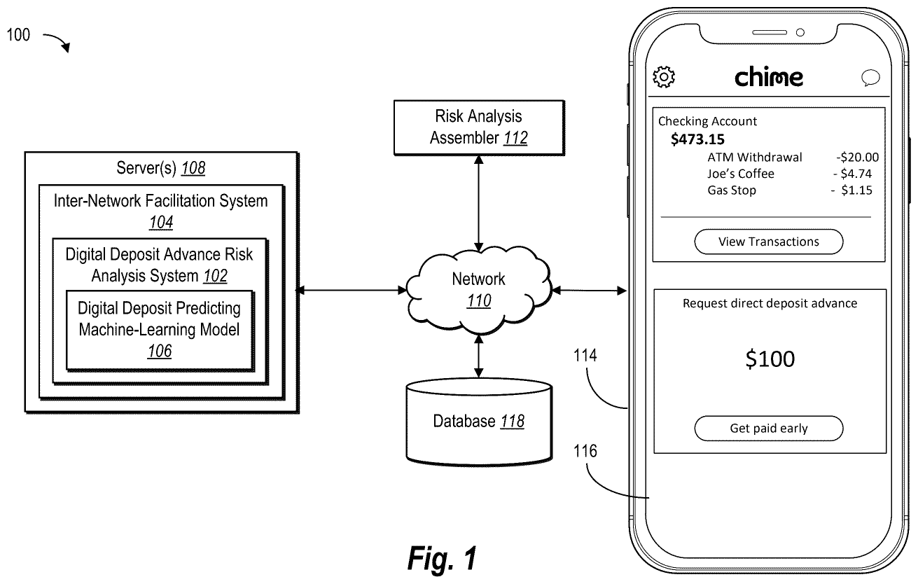

As used herein, the term “user account data” refers to information (or data) associated with interactions of a user within and/or in connection with an inter-network facilitation system (as described in FIG. 1). To illustrate, user account data can include, but is not limited to, historical utilization of an application, historical transaction activity within the user account (e.g., payments, setting changes, payment scheduling), historical deposit transactions, client device data (e.g., geo-location data, phone number data), historical withdrawal transactions, deposit transaction source information (e.g., employer, account information for deposit transaction party, pay stub data), and/or user data (e.g., address, email address, employment, estimated income).

Turning now to the figures, FIG. 1 illustrates a block diagram of a system 100 (or system environment) for implementing an inter-network facilitation system 104 and a digital direct deposit advance risk analysis system 102 in accordance with one or more embodiments. As shown in FIG. 1, system 100 includes server(s) 108 (which includes the inter-network facilitation system 104, the digital direct deposit advance risk analysis system 102, and the digital direct deposit predictor machine-learning model 106), a risk analysis assembler 112, a client device 114, and a database 118. As further illustrated in FIG. 1, the server(s) 108, the client device 114, and the risk analysis assembler can communicate via the network 110.

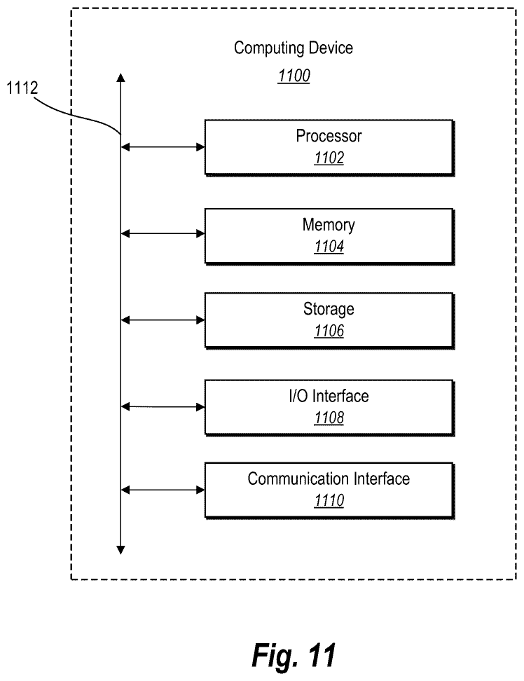

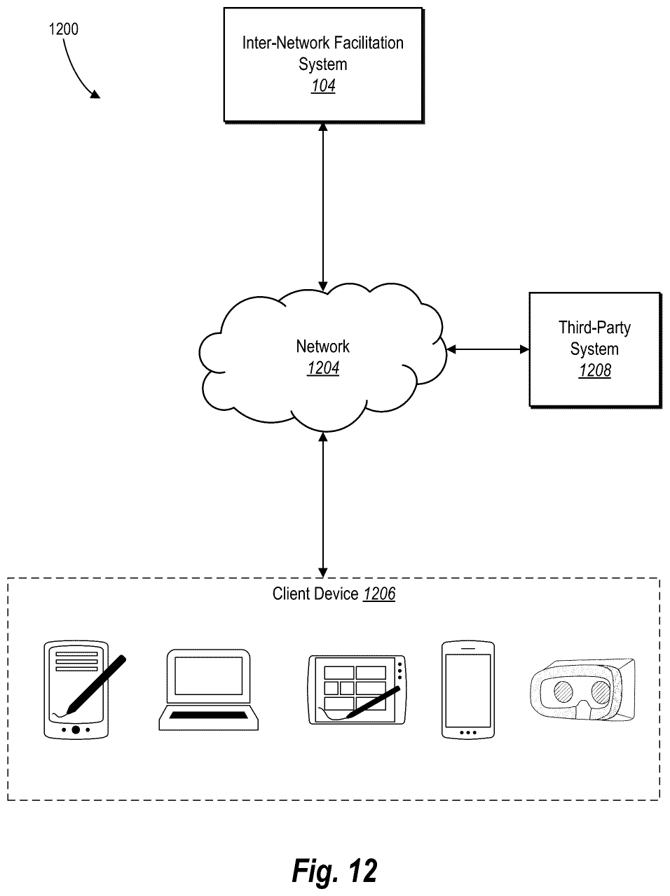

Although FIG. 1 illustrates the digital direct deposit advance risk analysis system 102 being implemented by a particular component and/or device within system 100, the digital direct deposit advance risk analysis system 102 can be implemented, in whole or in part, by other computing devices and/or components in the system 100 (e.g., the client device 114). Additional description regarding the illustrated computing devices (e.g., the server(s) 108, computing devices implementing the digital direct deposit advance risk analysis system 102, the client device 114, and/or the network 110) is provided with respect to FIGS. 11 and 12 below.

As shown in FIG. 1, the server(s) 108 can include the inter-network facilitation system 104. In some embodiments, the inter-network facilitation system 104 can determine, store, generate, and/or display financial information corresponding to a user account (e.g., a banking application or a money transfer application). Furthermore, the inter-network facilitation system 104 can also electronically communicate (or facilitate) financial transactions between one or more user accounts (and/or computing devices). Moreover, the inter-network facilitation system 104 can also track and/or monitor financial transactions and/or financial transaction behaviors of a user within a user account.

The inter-network facilitation system 104 can include a system that comprises the digital direct deposit advance risk analysis system 102, and that facilitates financial transactions and digital communications across different computing systems over one or more networks. For example, the inter-network facilitation system 104 manages credit accounts, secured accounts, and other accounts for one or more accounts registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

Furthermore, as shown in FIG. 1, system 100 also includes the risk analysis assembler 112. In one or more embodiments, the risk analysis assembler receives or accesses a digital direct deposit likelihood from the digital direct deposit predictor machine-learning model and/or user data to generate a risk classification for a network transaction. For instance, the risk analysis assembler can access user data from database 118 and utilize the user account data with the digital direct deposit predictor model to determine various risk classifications and, subsequently, use the risk classification for downstream determinations of digital direct deposit advance amounts. Moreover, although system 100 illustrates the risk analysis assembler 112 communicating with the inter-network facilitation system 104, in one or more embodiments, the risk analysis assembler 112 is implemented within the server(s) 108 (e.g., as part of the inter-network facilitation system 104).

As also illustrated in FIG. 1, the system 100 includes the client device 114. For example, the client device 114 may include, but is not limited to, mobile devices (e.g., smartphones, tablets) or other types of computing devices, including those explained below with reference to FIGS. 11 and 12. Additionally, the client device 114 can include computing devices associated with (and/or operated by) user accounts for the inter-network facilitation system 104. Moreover, system 100 can include various numbers of client devices that communicate and/or interact with the inter-network facilitation system 104 and/or the digital direct deposit advance risk analysis system 102.

Furthermore, as shown in FIG. 1, the client device 114 can include a client application 116. Client application 116 can include instructions that (upon execution) cause the client device 114 to perform various actions. For example, a user of a user account can interact with the client application 116 on the client device 114 to access financial information, initiate a financial transaction (e.g., transfer money to another account, deposit money, withdraw money), and/or access or provide data (to the server(s) 108). Furthermore, in one or more implementations, the client application 116 can display one or more graphical user interfaces from which the digital direct deposit risk analysis system can receive and display information regarding network transactions.

In certain instances, the client device 114 corresponds to one or more user accounts (e.g., user accounts stored at the server(s) 108). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices.

The present disclosure utilizes client devices to refer to devices associated with such user accounts. In referring to a client (or user) device, the disclosure and the claims are not limited to communications with a specific device but any device corresponding to a user account of a particular user. Accordingly, in using the term client device, this disclosure can refer to any computing device corresponding to a user account of the inter-network facilitation system 104.

As further shown in FIG. 1, the system 100 includes the network 110. As mentioned above, the network 110 can enable communication between components of the system 100. In one or more embodiments, the network 110 may include a suitable network and may communicate using a various number of communication platforms and technologies suitable for transmitting data and/or communication signals, examples of which are described with reference to FIG. 12. Furthermore, although FIG. 1 illustrates the server(s) 108, the risk analysis assembler 112, the client device 114, and the database 118 communicating via the network 110, the various components of the system 100 can communicate and/or interact via other methods (e.g., the server(s) 108 and the client device 114 can communicate directly).

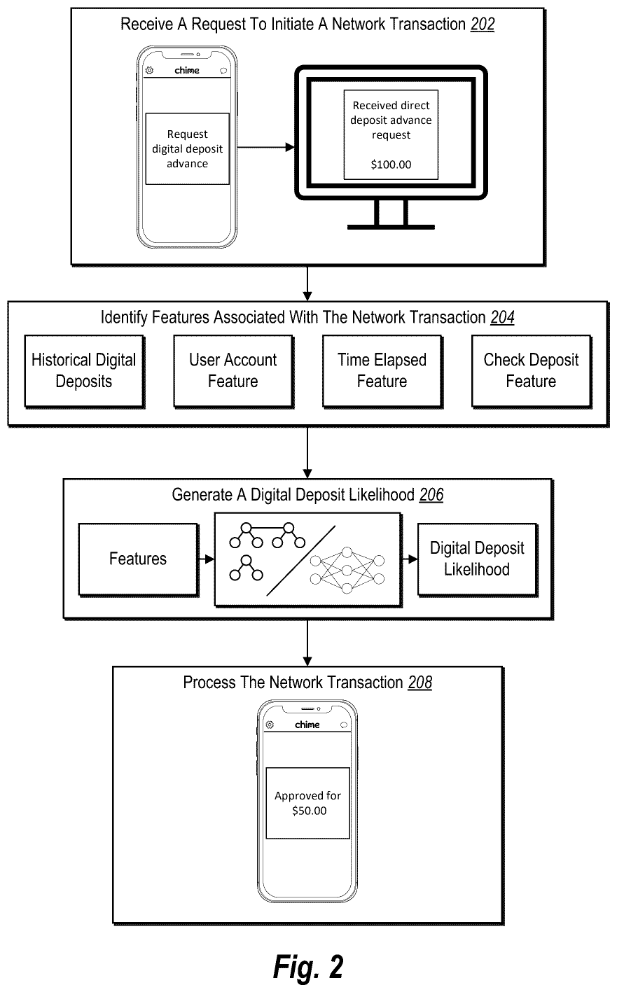

As mentioned, the digital direct deposit advance risk analysis system 102 generates a digital direct deposit likelihood for a network transaction. In particular, the digital direct deposit advance risk analysis system 102 utilizes a digital direct deposit predictor machine-learning model to generate a digital direct deposit likelihood for a network transaction comprising a digital direct deposit advance request. FIG. 2 illustrates an overview of the digital direct deposit advance risk analysis system 102 generating a digital direct deposit likelihood in accordance with one or more embodiments. Additional detail regarding the various acts illustrated in FIG. 2 is provided thereafter with reference to subsequent figures.

As illustrated in FIG. 2, the digital direct deposit advance risk analysis system 102 performs an act 202 and receives a request to initiate a network transaction. In particular, the digital direct deposit advance risk analysis system 102 receives a request to initiate a network transaction comprising a digital direct deposit advance request. In some cases, the request to initiate a network transaction can comprise additional information, such as a requested amount for the digital direct deposit advance. As shown, the digital direct deposit advance risk analysis system 102 receives a request to initiate a network transaction comprising a digital direct deposit advance request from a client device associated with the network transaction comprising a requested digital direct deposit amount of $100.

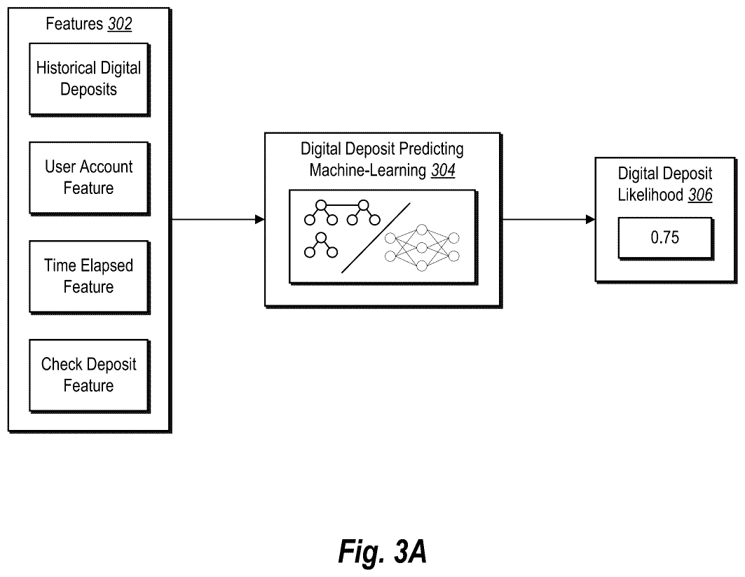

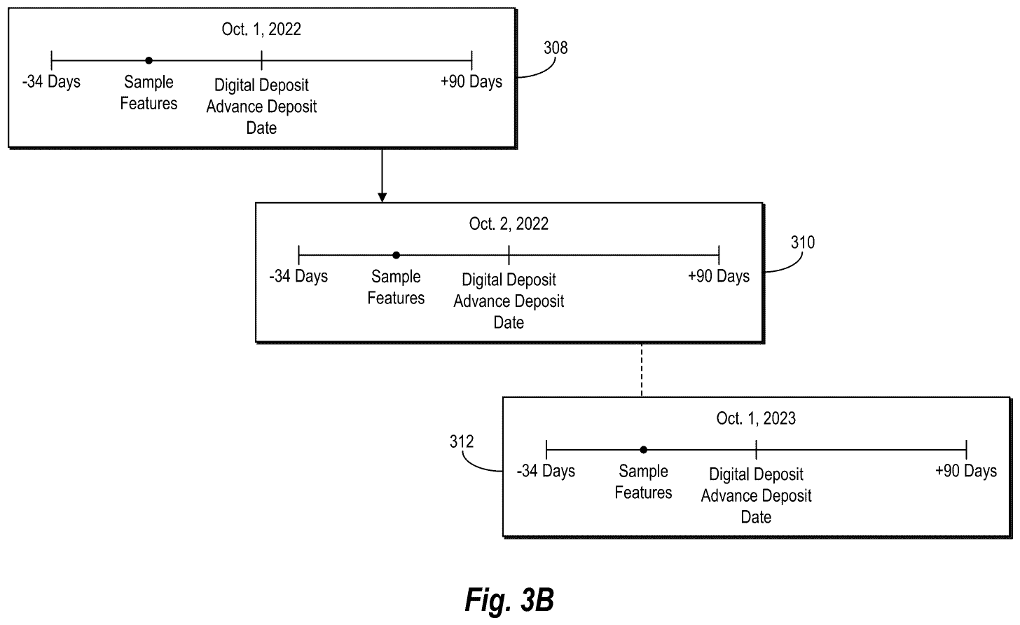

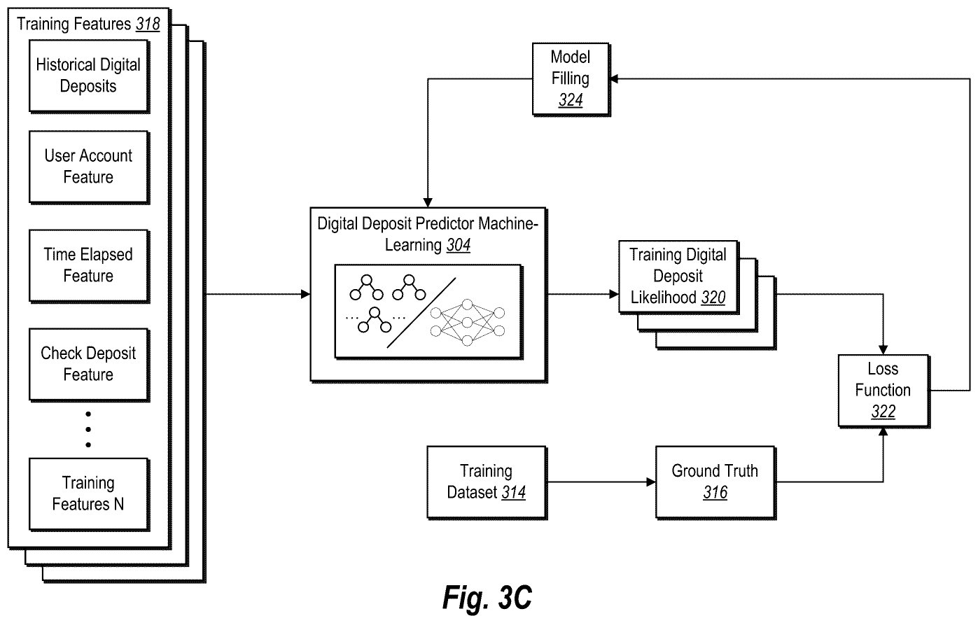

As further illustrated in FIG. 2, the digital direct deposit advance risk analysis system 102 performs an act 204 and identifies features associated with the network transaction. In particular, the digital direct deposit advance risk analysis system 102 can identify or extract features associated with the network transaction or other features such as, for example, historical digital direct deposit features, user account features, check deposit features, application activity features, check deposit features, account balance features, physical card features, peer-to-peer transaction features, customer service ticket features, or time elapsed features. Further detail regarding identifying features associated with the network transaction will be provided with regard to FIG. 3A below.

As also illustrated in FIG. 2, the digital direct deposit advance risk analysis system 102 performs an act 206 and generates a digital direct deposit likelihood. In particular, the digital direct deposit advance risk analysis system 102 utilizes a digital direct deposit predictor machine-learning model to process or analyze one or more features associated with the network transaction and generate a digital direct deposit likelihood for the network transaction. As shown, in some cases, the digital direct deposit predictor machine-learning model can be a series of gradient-boosted trees (e.g., XGBoost algorithm), or the digital direct deposit predictor machine-learning model can be another machine-learning model, such as a neural network. Additional detail regarding generating a training dataset and training a digital direct deposit predictor machine-learning model is provided below with respect to FIGS. 3B-3C below.

In some embodiments, the digital direct deposit advance risk analysis system 102 generates a training dataset to use when training the digital direct deposit predictor machine-learning model. In particular, the digital direct deposit advance risk analysis system 102 generates a training dataset by identifying network transactions comprising digital direct deposit advance requests in which a user account associated with the network transaction previously received a digital direct deposit. Additional detail regarding generating a training dataset and utilizing the training dataset to train a digital direct deposit predictor machine-learning model is provided below with respect to FIGS. 3A-3C below.

Further, in one or more embodiments, the digital direct deposit advance risk analysis system 102 can also generate a deposit transaction prediction for the network transaction. More specifically, the digital direct deposit advance risk analysis system 102 utilizes a deposit transaction predictor model to generate a deposit transaction prediction for the network transaction. In some cases, the deposit transaction predictor model is a model as described in U.S. application Ser. No. 18/153,814, filed Aug. 30, 2023, entitled GENERATING GRAPHICAL USER INTERFACES COMPRISING DYNAMIC AVAILABLE DEPOSIT TRANSACTION VALUES DETERMINED FROM A DEPOSIT TRANSACTION PREDICTOR MODEL (hereinafter “application Ser. No. 18/153,814”), the contents of which are herein incorporated by reference in their entirety. In one or more embodiments, the deposit transaction predictor model can work in conjunction with (or in series with) a digital direct deposit preditor machine-learning model to generate a deposit transaction prediction that indicates, predicts, or forecasts a digital direct deposit (e.g., an anticipated amount for an anticipated digital direct deposit or anticipated timing of an anticipated digital direct deposit).

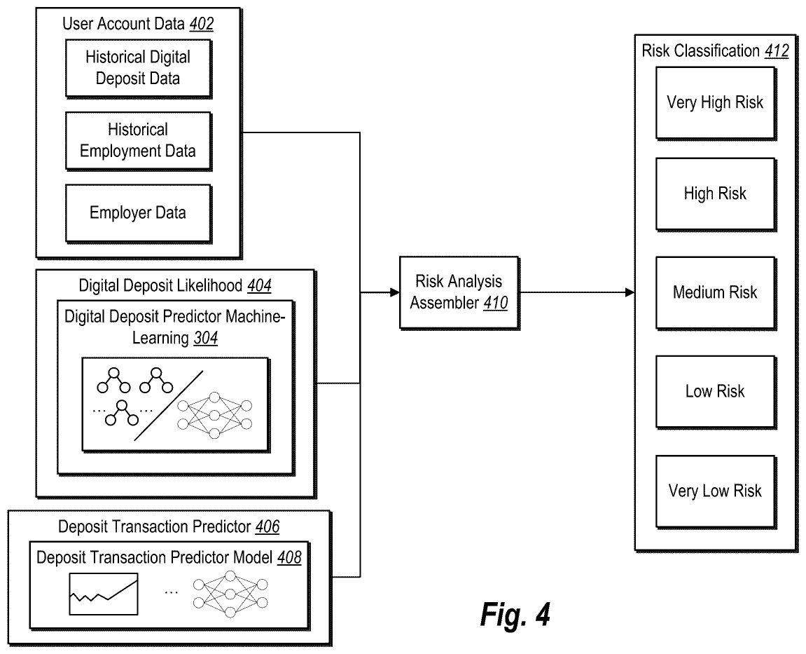

Additionally, in one or more embodiments, the digital direct deposit advance risk analysis system 102 can generate a risk classification for the network transaction based on a digital direct deposit likelihood and/or a deposit transaction prediction. In particular, the digital direct deposit advance risk analysis system 102 utilizes a risk analysis assembler to generate a risk classification based on the digital direct deposit likelihood, a deposit transaction prediction, and/or user account data (e.g., historical digital direct deposit data, historical employment data, and/or employer data). Additional detail regarding generating a deposit transaction prediction and utilizing a risk analysis assembler to generate a risk classification for a network transaction is provided below with respect to FIG. 4 below.

Further, as illustrated in FIG. 2, the digital direct deposit advance risk analysis system 102 performs an act 208 and processes the network transaction. In particular, the digital direct deposit advance risk analysis system 102 utilizes a digital direct deposit likelihood and/or a risk classification to process a network transaction. For example, the digital direct deposit advance risk analysis system 102 can process a network by applying transaction logic to approve or deny the network transaction according to a digital direct deposit likelihood and/or a risk classification. In some cases, the digital direct deposit advance risk analysis system 102 will process the network transaction by determining an eligible digital direct deposit amount for the network transaction. In other cases, the digital direct deposit advance risk analysis system 102 will process the network transaction by identifying that the digital direct deposit likelihood and/or the risk classification indicate that a user account associated with the network transaction will not receive a future digital direct deposit and deny the network transaction.

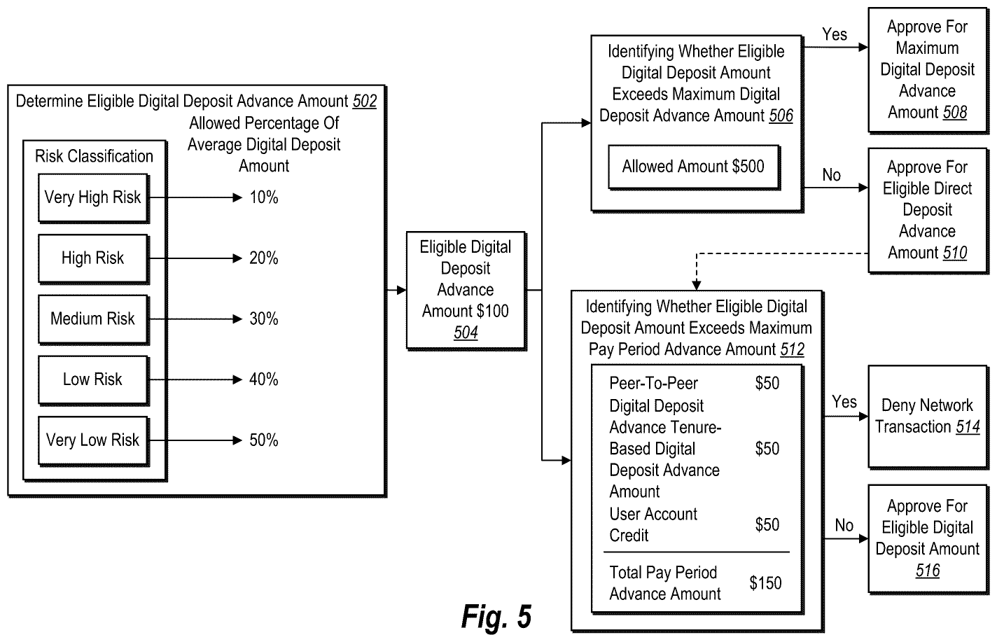

Further, in one or more embodiments, the digital direct deposit advance risk analysis system 102 can approve the network transaction for an amount other than an eligible amount of the digital direct deposit amount based on limits (e.g., regulations on digital direct deposit limits) or other credits and/or liabilities associated with the user account. For example, in some cases, the digital direct deposit advance risk analysis system determines that an eligible digital direct deposit amount exceeds a maximum digital direct deposit advance amount and approves the network transaction for the maximum digital direct deposit advance amount (or less). In other cases, the digital direct deposit advance risk analysis system determines that an eligible digital direct deposit amount exceeds a maximum pay period advance amount, either alone or in conjunction with other credits and/or liabilities associated with the user account (e.g., peer-to-peer transaction amounts, limits based on digital direct deposit advance tenure, and/or user account credit limits) and determines a digital direct deposit advance amount based on the maximum pay period advance amount. Further detail regarding the digital direct deposit advance risk analysis system 102 processing network transactions according to digital direct deposit likelihood and/or risk classification will be discussed further with respect to FIG. 5 below.

As mentioned, the digital direct deposit advance risk analysis system 102 trains and utilizes a digital direct deposit predictor machine-learning model to generate digital direct deposit likelihoods for network transactions based on features of the network transaction. FIGS. 3A-3C illustrate the digital direct deposit advance risk analysis system 102 training and utilizing the the digital direct deposit predictor machine-learning model. Specifically, FIG. 3A illustrates digital direct deposit advance risk analysis system 102 identifying features and generating a digital direct deposit prediction for a network transaction, FIG. 3B illustrates the digital direct deposit advance risk analysis system 102 generating a training dataset, and FIG. 3C illustrates digital direct deposit advance risk analysis system 102 utilizing the training dataset to train a digital direct deposit predictor machine-learning model to generate accurate digital direct deposit likelihoods.

As illustrated in FIG. 3A, the digital direct deposit advance risk analysis system 102 identifies features 302. In particular, the digital direct deposit advance risk analysis system 102 identifies features associated with a network transaction. For example, the digital direct deposit advance risk analysis system 102 can identify features by identifying feature groups (or feature families) that represent groups or sets of related features or attributes to represent data (e.g., data associated with the network transaction). As shown, the digital direct deposit advance risk analysis system 102 can identify feature groups by identifying historical digital direct deposit features, user account features, time elapsed features, and/or check deposit features. The digital direct deposit advance risk analysis system 102 can also identify feature groups related to application activity features, peer-to-peer transaction activity features, customer service ticket features, historical account balance features, historical transaction features, historical card activity features, base value determination features, and/or derived variable features.

In addition to identifying feature families, the digital direct deposit advance risk analysis system 102 can also identify individual features within each feature group. In particular, the digital direct deposit advance risk analysis system 102 can identify individual features that relate to specific instances within each feature family or include one or more individual features that identify information related to the feature family. For example, individual features can include more data that expresses specific characteristics of the general data within a feature group. To illustrate, a historical data feature group can include individual features such as a digital direct deposit count feature, a total payroll digital direct deposit count feature, a total digital direct deposit amount to total payroll amount ratio feature, a digital direct deposit to payroll ratio feature, a digital direct deposit source feature, a digital direct deposit count by employer feature, a most recent digital direct deposit amount feature, a digital direct deposit count by payroll feature, a total digital direct deposit amount feature and/or a total digital direct deposit ratio feature.

As another illustration, a time elapsed feature group may include individual features such as an elapsed time since last digital direct deposit feature, a digital direct deposit enrollment time feature, a days since last digital direct deposit feature, and/or an elapsed time since first digital direct deposit feature. To further illustrate, a historical transaction feature group can include individual features such as a settled transaction count feature and/or a settled transaction total amount feature. Moreover, to illustrate, a base value determination feature can include individual features such as an unpaid base value balance count feature, a recent base value status feature, a historical unpaid base value amount feature, a historical unpaid base value count feature, a historical base value count feature, and/or a historical base value total write-off value feature. As an additional illustration, a derived variable feature group can include individual features (or other feature groups) such as a ratio variable feature and/or a days since event variable feature.

After identifying features, and prior to providing the features to the digital direct deposit predictor machine-learning model, the digital direct deposit advance risk analysis system 102 can preprocess the features. Specifically, the digital direct deposit advance risk analysis system 102 can preprocess the features by imputing or replacing missing data with a median or mode of the feature. For example, the digital direct deposit advance risk analysis system 102 can impute the median or mode by estimating values from a set of data, such as a training data set. In some cases, the digital direct deposit advance risk analysis system 102 can impute the median of a feature by imputing the middle number value for a feature in a set of features sorted by value. In other cases, the digital direct deposit advance risk analysis system 102 can impute the mean of a feature by imputing the most common value for a feature.

In addition to imputing the median or mode, the digital direct deposit advance risk analysis system 102 can preprocess the features by utilizing target encoding to convert categorical data to numerical variables. For example, the digital direct deposit advance risk analysis system 102 can utilize target encoding by replacing a categorical value with the mean of a target variable, where the mean is calculated from a distribution of target values for that particular level of categorical feature. Further, the digital direct deposit advance risk analysis system 102 can place more or less importance on the average for the target values based on the size of the category. For example, if a feature category is small, the digital direct deposit advance risk analysis system 102 can determine to place less importance on the category by imputing a smaller average for the feature category.

In one or more embodiments, the digital direct deposit advance risk analysis system 102 can also determine a relative importance of features. In particular, the digital direct deposit advance risk analysis system 102 can determine feature importance in order to identify a value of a particular feature in relation to another feature. For example, by determining relative importance, the digital direct deposit advance risk analysis system 102 can rank features on a scale according to their relative importance. Accordingly, the digital direct deposit advance risk analysis system 102 can identify features that make an impact on determining the digital direct deposit likelihood and elect to use those features. To illustrate, the digital direct deposit advance risk analysis system 102 can elect to keep features that are above a feature value threshold or to keep a certain number of features. By optimizing for features for the value they contribute, the digital direct deposit advance risk analysis system 102 can decrease processing time while still generating accurate digital direct deposit likelihoods.

Additionally, in other embodiments, the digital direct deposit advance risk analysis system 102 can determine the contribution of features. In particular, the digital direct deposit advance risk analysis system 102 can determine the amount of impact a feature has on the performance of the digital direct deposit predictor machine-learning model. For example, the digital direct deposit advance risk analysis system 102 can determine a Shapley Additive Explanations (SHAP) value for each feature.

After identifying features 302, the digital direct deposit advance risk analysis system 102 utilizes a digital direct deposit predictor machine-learning model 304 to generate a digital direct deposit likelihood 306. Specifically, the digital direct deposit advance risk analysis system 102 generates a digital direct deposit likelihood or digital direct deposit classification indication as a probability that a user account associated with a network transaction will receive a future digital direct deposit within a future digital direct deposit timeframe. In some cases, the digital direct deposit predictor machine-learning model 304 is a series of gradient-boosted trees that process the features 302 to generate the digital direct deposit likelihood 306. For instance, the digital direct deposit predictor machine-learning model 304 can include a series of weak learners, such as non-linear decision trees, that are trained in a logistic regression to generate the digital direct deposit likelihood 306. For example, the digital direct deposit predictor machine-learning model 304 generates the digital direct deposit likelihood 306 as a classifier or with a corresponding probability that a user account associated with the network transaction will receive a future digital direct deposit within a future digital direct deposit timeframe and/or a classifier with a corresponding probability that the user account associated with the network transaction will not receive a future digital direct deposit within a future digital direct deposit timeframe.

In some cases, the digital direct deposit predictor machine-learning model 304 is an ensemble of gradient-boosted trees that process the features to generate a digital direct deposit likelihood. In some cases, the digital direct deposit predictor machine-learning model 304 includes metrics within various trees that define how the digital direct deposit predictor machine-learning model 304 processes the features to generate the digital direct deposit likelihood 306.

In one or more embodiments, the digital direct deposit predictor machine-learning model 304 is a different type of machine-learning model, such as a neural network, a support vector machine, or a random forest. For example, in cases where the digital direct deposit predictor machine-learning model 304 is a neural network, the digital direct deposit predictor machine-learning model 304 includes one or more layers with learned parameters for analyzing/processing input features and/or latent feature vectors from previous layers. In some cases, the digital direct deposit predictor machine-learning model 304 generates the digital direct deposit likelihood 306 by extracting latent vectors from the features, passing the latent vectors from layer to layer (or neuron to neuron) to manipulate the vectors until utilizing an output layer (e.g., one or more fully connected layers) to generate the digital direct deposit likelihood 306.

In one or more embodiments, the digital direct deposit advance risk analysis system 102 generates digital direct deposit likelihood 306 by generating a classification or metric indication of whether a network transaction utilizes compromised credit card information. For example, in some embodiments, digital direct deposit likelihood 306 can be a binary classifier, such as a “positive” or “negative,” a “0” or “1,” or a “yes” or “no,” indicating whether or not the digital direct deposit predictor machine-learning model predicts a user account will receive a digital direct deposit. In other embodiments, the digital direct deposit likelihood 306 can comprise a numerical score (e.g., a number, a fraction, or other numerical indicators) indicating a degree to which a digital direct deposit predictor machine-learning model predicts that a user account will receive a digital direct deposit.

As previously mentioned, in one or more embodiments, the digital direct deposit advance risk analysis system 102 generates a training dataset. More specifically, the digital direct deposit advance risk analysis system 102 samples and labels data to generate a training dataset to use in training the digital direct deposit predictor machine-learning model 304. FIG. 3B illustrates generating a training dataset in accordance with one or more embodiments.

In one or more embodiments, the digital direct deposit advance risk analysis system 102 accesses data associated with network transactions at various time points corresponding to digital direct deposit advance requests. In particular, the digital direct deposit advance risk analysis system 102 can sample features constituting a feature from any of the feature groups or individual features described herein (e.g., with respect to FIG. 3A above).

Further, in one or more embodiments, the digital direct deposit advance risk analysis system 102 elects to sample features where the digital direct deposit advance risk analysis system 102 identifies that a user account associated with the digital direct deposit advance request received at least one prior digital direct deposit. In particular, the digital direct deposit advance risk analysis system 102 can identify that a digital direct deposit advance request is associated with a user account and detect whether the user account received a digital direct deposit within a previous digital direct deposit timeframe. For example, the digital direct deposit advance risk analysis system 102 can identify whether the user account received a digital direct deposit within the 30 days prior to receiving the digital direct deposit advance request associated with the user account. In cases where the digital direct deposit advance risk analysis system 102 identifies that the user account did not receive a digital direct deposit within the 30 days or 34 days prior to receiving the digital direct deposit advance request, the digital direct deposit advance risk analysis system 102 can elect to not sample features (e.g., proceeding to sample features from a different set of data where a user account received a digital direct deposit within the previous digital direct deposit timeframe).

As shown in FIG. 3B, the digital direct deposit advance risk analysis system 102 can sample features at various time intervals. Specifically, the digital direct deposit advance risk analysis system 102 can sample features at a first time period, then a second time period, and so forth. For example, as shown, the digital direct deposit advance risk analysis system 102 can sample features at a first time period 308 (e.g., Oct. 1, 2022), again at a second time period 310 (e.g., Oct. 2, 2022), and can continue sampling features at additional time periods 312 perpetuity or for a set amount of time (e.g., sampling features once a day for a year, as shown).

After sampling features, the digital direct deposit advance risk analysis system 102 identifies whether a user account received a future digital direct deposit within a future digital direct deposit timeframe. Specifically, the digital direct deposit advance risk analysis system 102 continuously monitors a user account from which the digital direct deposit advance risk analysis system 102 sampled features to identify if the user account received a digital direct deposit within the future digital direct deposit timeframe. In some cases, a future digital direct deposit timeframe denotes an amount of time in which the digital direct deposit advance risk analysis system 102 anticipates that a user account will receive a digital direct deposit (e.g., a future digital direct deposit). For example, after providing a digital direct deposit advance, a future digital direct deposit timeframe represents a time frame within which the digital direct deposit advance risk analysis system 102 anticipates, identifies, or watches for a digital direct deposit (e.g., to cover digital assets, tokens, or currency advanced in a digital direct deposit advance). To illustrate, the digital direct deposit advance risk analysis system 102 monitors a user account for a set timeframe (e.g., 90 days) to identify if the user account received a digital direct deposit advance in the future digital direct deposit timeframe.

In one or more embodiments, after sampling the features at various time periods, the digital direct deposit advance risk analysis system 102 labels the training dataset. Specifically, the digital direct deposit advance risk analysis system 102 labels the training dataset to identify or assign correct target or output values to each feature (or data point). For example, the digital direct deposit advance risk analysis system 102 labels the training dataset by identifying or assigning whether a user account associated with sampled features received a digital direct deposit. To illustrate, the digital direct deposit advance risk analysis system 102 labels the training dataset according to whether the sampled features (or combination of features) correspond to an instance where a user account received a digital direct deposit within the future digital direct deposit timeframe (e.g., 90 days). Indeed, the digital direct deposit advance risk analysis system 102 treats the labeled dataset as a ground truth when training the digital direct deposit predictor machine-learning model 304.

As previously mentioned, the digital direct deposit advance risk analysis system 102 utilizes the training dataset to train or tune a digital direct deposit predictor machine-learning model to generate accurate digital direct deposit likelihoods. In particular, the digital direct deposit advance risk analysis system 102 utilizes an iterative training process to fit a digital direct deposit predictor machine-learning model by adjusting or adding decision trees or learning parameters that result in accurate digital direct deposit likelihoods. FIG. 3C illustrates the digital direct deposit advance risk analysis system 102 training a digital direct deposit predictor machine-learning model in accordance with one or more embodiments.

As illustrated in FIG. 3C, the digital direct deposit advance risk analysis system 102 accesses a training dataset 314. The training dataset constitutes training features used to train the digital direct deposit predictor machine-learning model 304. The training features 318 have corresponding ground truth 316, where the ground truth indicates whether a user account associated with a network transaction (or a digital direct deposit request) received a digital direct deposit in a future digital direct deposit timeframe (e.g., a digital direct deposit advance was covered by a future digital direct deposit). For example, the training dataset 314 can be the training dataset as described above in reference to FIG. 3B. Accordingly, the digital direct deposit advance risk analysis system 102 treats the labeled training dataset as ground truth 316 for training or tuning the digital direct deposit predictor machine-learning model 304.

As also illustrated in FIG. 3C, the digital direct deposit advance risk analysis system 102 provides training features 318 associated with the training dataset 314 to the digital direct deposit predictor machine-learning model 304 to generate a training digital direct deposit likelihood 320. As the name indicates, the training features 318 represent the features associated with the training dataset 314 that are used for training the digital direct deposit predictor machine-learning model 304. In some embodiments, the digital direct deposit predictor machine-learning model generates a set of training digital direct deposit likelihoods 320, including a predicted digital direct deposit likelihood with a corresponding probability or indicator that the training features 318 indicate a user account will receive a digital direct deposit within a future digital direct deposit timeframe and/or a probability or likelihood that the training features 318 indicate that a user account will not receive a digital direct deposit within a future digital direct deposit timeframe. The training digital direct deposit likelihood 320 can take the form of any of the digital direct deposit likelihoods described above.

As also illustrated in FIG. 3B, the digital direct deposit advance risk analysis system 102 utilizes a loss function 322 to compare the training dataset 314 and the ground truth 316 (e.g., to determine an error or a measure of loss between them). For instance, in cases where the digital direct deposit predictor machine-learning model 304 is an ensemble of gradient-boosted trees, the digital direct deposit advance risk analysis system utilizes a mean squared error loss function (e.g., for regression) and/or a logarithmic loss function (e.g., for classification) as the loss function 322.

By contrast, in embodiments where the digital direct deposit predictor machine-learning model 304 is a neural network, the digital direct deposit advance risk analysis system 102 can utilize a cross-entropy loss function, an L1 loss function, or a mean squared error loss function as the loss function 322. For example, the digital direct deposit advance risk analysis system 102 utilizes the loss function 322 to determine a difference between the training dataset 314 and the ground truth 316.

As further illustrated in FIG. 3B, the digital direct deposit advance risk analysis system 102 performs model fitting 324. In particular, the digital direct deposit advance risk analysis system 102 fits the digital direct deposit predictor machine-learning model 304 based on loss from the loss function 322. For instance, the digital direct deposit advance risk analysis system 102 performs modifications or adjustments to the digital direct deposit predictor machine-learning model 304 to reduce the measure of loss from the loss function 322 for a subsequent training iteration.

For gradient-boosted trees, for example, the digital direct deposit advance risk analysis system 102 trains the digital direct deposit predictor machine-learning model 304 on the gradients of errors determined by the loss function 322. For instance, the digital direct deposit advance risk analysis system 102 solves a convex optimization problem (e.g., of infinite dimensions) while regularizing the objective to avoid overfitting. In certain implementations, the digital direct deposit advance risk analysis system 102 scales the gradients to emphasize corrections to under-represented classes.

In some embodiments, the digital direct deposit advance risk analysis system 102 adds a new weak learner (e.g., a new boosted tree) to the digital direct deposit predictor machine-learning model 304 for each successive training iteration as part of solving the optimization problem. For example, the digital direct deposit advance risk analysis system 102 finds a feature that minimizes a loss from the loss function 322 and either adds the feature to the current iteration's tree or starts to build a new tree with the feature.

In addition to, or in the alternative, gradient-boosted decision trees, the digital direct deposit advance risk analysis system 102 trains a logistic regression to learn parameters for generating one or more digital direct deposit likelihoods, such as a score indicating a probability of a user account receiving a digital direct deposit. To avoid overfitting, the digital direct deposit advance risk analysis system 102 further regularizes based on hyperparameters such as the learning rate, stochastic gradient boosting, the number of trees, the tree-depth(s), complexity penalization, and L1/L2 regularization.

In embodiments where the digital direct deposit predictor machine-learning model 304 is a neural network, the digital direct deposit advance risk analysis system 102 performs the model fitting 324 by modifying internal parameters (e.g., weights) of the digital direct deposit predictor machine-learning model 304 to reduce the measure of loss for the loss function 322. Indeed, the digital direct deposit advance risk analysis system 102 modifies how the digital direct deposit predictor machine-learning model 304 analyzes and passes data between layers and neurons by modifying the internal network parameters. Thus, over multiple iterations, the digital direct deposit advance risk analysis system 102 improves the accuracy of the digital direct deposit predictor machine-learning model 304.

Indeed, in some cases, the digital direct deposit advance risk analysis system 102 repeats the training process illustrated in FIG. 3B for multiple iterations. For example, the digital direct deposit advance risk analysis system 102 repeats the iterative training by selecting a new set of training features 318 for each training digital claim along with a corresponding ground truth 316. The digital direct deposit advance risk analysis system 102 further generates a new set of training digital direct deposit likelihoods 320 for each iteration. As described above, the digital direct deposit advance risk analysis system 102 also compares a training dataset 314 at each iteration with the corresponding ground truth 316 and further performs model fitting 324. The digital direct deposit advance risk analysis system 102 repeats this process until the digital direct deposit predictor machine-learning model 304 generates training digital direct deposit likelihoods 320 that result in digital direct deposit likelihoods that satisfy a threshold measure of loss.

As previously mentioned, in one or more embodiments, the digital direct deposit advance risk analysis system 102 generates a risk classification for a network transaction. In particular, the digital direct deposit advance risk analysis system 102 utilizes a digital direct deposit likelihood to generate a risk classification. FIG. 4 illustrates the digital direct deposit advance risk analysis system 102 utilizing a risk analysis assembler to generate a risk classification in accordance with one or more embodiments.

As mentioned, in one or more embodiments, the digital direct deposit advance risk analysis system 102 generates a risk classification from a digital direct deposit likelihood 404. For example, digital direct deposit likelihood 404 can be any of the digital direct deposit likelihoods as described above with respect to FIG. 3A. The digital direct deposit advance risk analysis system 102 can then use risk analysis assembler 410 to generate a risk classification 412 from digital direct deposit likelihood 404. In one or more embodiments, risk analysis assembler 410 is a software, code, or system that processes and/or executes data to produce a risk classification 412. In particular, risk analysis assembler 410 can be programmed (e.g., specifically coded) to receive data or other input from which to generate a risk classification. For example, risk analysis assembler 410 is programmed to generate a risk classification 412 from digital direct deposit likelihood 404 and, in some cases, user data 402 and/or a deposit transaction prediction 406.

As shown, user data 402 can comprise multiple types of data. In particular, user data 402 can comprise historical digital direct deposit data, historical employment data, and/or employer data. User data 402 can also comprise additional or specific forms of data, such as time elapsed with a digital direct deposit program, earned amount to date data, amount expected with next digital direct deposit (or other paycheck) data, wage rate data, hours worked by calendar day data, employer name. In some cases, the digital direct deposit advance risk analysis system 102 receives additional data inputs from sources associated with the digital direct deposit advance risk analysis system 102, such as other applications, third-party credit reporting agencies, or a third-party risk score, among others.

As mentioned, the risk analysis assembler 410 can also utilize deposit transaction prediction 406 to generate risk classification 412. In particular, the digital direct deposit advance risk analysis system 102 utilizes a deposit transaction predictor model 408 to generate the deposit transaction prediction. For example, deposit transaction predictor model 408 can comprise any of the models described in application Ser. No. 18/153,814 (incorporated by reference above). In some cases, deposit transaction predictor model 408 is a standalone model as part of digital direct deposit advance risk analysis system 102. In other cases, deposit transaction predictor model 408 works as part of (or in series with) digital direct deposit predictor machine-learning model 304.

In some embodiments, deposit transaction predictor model 408 is a model that determines (and/or outputs) deposit prediction data for a user account from user account data. For instance, deposit transaction predictor model 408 can include a mapping of information between various ranges or segments of user account data to various deposit transaction patterns (e.g., future deposit transaction dates, future deposit transaction amounts, future deposit transaction frequencies). Indeed, in one or more embodiments, deposit transaction predictor model 408 includes a rule-based model that determines patterns for future deposit transactions utilizing user account data, such as, but not limited to, historical user account deposit transactions. In some instances, deposit transaction predictor model 408 includes a machine-learning model that determines (or outputs) predicted deposit transaction patterns for a user account from input user account data (e.g., historical user account deposit transactions, geo-locations, user account transaction history).

In one or more embodiments, deposit transaction prediction 406 is a metric, classifier, or other indicator that predicts (or forecasts) information related to digital direct deposits. In particular, deposit transaction prediction 406 comprises a predicted deposit transaction amount (or an estimated deposit transaction amount) and/or a predicted digital direct deposit timing (e.g., predicting an estimated date for a digital direct deposit). For example, deposit transaction prediction 406 can be any of the predictions described in application Ser. No. 18/153,814.

As mentioned, risk analysis assembler 410 generates (or outputs) a risk classification 412 or risk score. Risk classification 412 can include a classification or metric indication representing the risk that a user account will not receive a digital direct deposit. For example, in some embodiments, risk classification 412 can comprise a binary classifier, such as “positive” or “negative,” a “0” or “1,” or a “yes” or “no,” for a risk category (e.g., very high risk, high risk, medium risk, low risk, very low risk). In other embodiments, risk classification 412 can comprise a numerical score (e.g., a number, a fraction, or other numerical indicators) indicating a degree of risk associated with the network transaction (e.g., a risk that a user account will not receive a digital direct deposit).

In one or more embodiments, the digital direct deposit advance risk analysis system 102 assigns a risk classification 412 based on a risk metric or risk score generated (or output) by the risk analysis assembler 410. In particular, the digital direct deposit advance risk analysis system 102 can assemble or aggregate risk scores from risk analysis assembler 410 and assign or identify a risk classification 412 for each network transaction based on the risk score. For example, the digital direct deposit advance risk analysis system 102 can rank (or order) the risk scores according to value, divide the risk scores into ten deciles, and assign a risk classification according to the decile in which the risk score falls. In some cases, the digital direct deposit advance risk analysis system 102 assigns a risk classification to multiple deciles. For example, the digital direct deposit advance risk analysis system 102 can assign a first and second decile a risk classification of “very high risk,” a third decile a risk classification of “high risk,” a fourth and fifth decile a risk classification of “medium risk,” a sixth and seventh decile a risk classification of “low risk,” and an eighth, ninth, and tenth decile a risk classification of “very low risk.”

As previously mentioned, in one or more embodiments, the digital direct deposit advance risk analysis system 102 processes a network transaction based on a digital direct deposit likelihood and/or a risk classification. In particular, the digital direct deposit advance risk analysis system 102 can process a network transaction by determining a digital direct deposit advance amount or denying the transaction based on the digital direct deposit likelihood and/or risk classification. FIG. 5 illustrates processing a network transaction in accordance with one or more embodiments.

As shown, the digital direct deposit advance risk analysis system 102 determines an eligible digital direct deposit advance amount at step 502. In particular, the digital direct deposit advance risk analysis system 102 determines an eligible digital direct deposit advance amount based on the risk classification. For example, the digital direct deposit advance risk analysis system 102 can assign an allowed percentage of an average digital direct deposit amount for a user account associated with the network transaction. As shown, the digital direct deposit advance risk analysis system 102 can assign lower risk classifications (e.g., low risk, very low risk) a higher percentage of an average digital direct deposit amount and assign higher risk classifications (e.g., very high risk, high risk, medium risk) a lower percentage of an average digital direct deposit amount. Based on the determinations from step 502, the digital direct deposit advance risk analysis system 102 determines (or calculates) an eligible digital direct deposit advance amount 504.

In one or more embodiments, the digital direct deposit advance risk analysis system 102 identifies or determines that the eligible digital direct deposit advance amount exceeds a maximum digital direct deposit advance amount at step 506. In particular, the digital direct deposit advance risk analysis system 102 compares the eligible digital direct deposit advance amount to a maximum digital direct deposit advance amount in order to determine an amount for which to approve a network transaction. A maximum digital direct deposit advance amount can be a maximum amount allowed for a digital direct deposit advance (e.g., due to government regulations or other digital direct deposit rules). If the digital direct deposit advance risk analysis system 102 identifies that the eligible digital direct deposit advance amount exceeds the maximum digital direct deposit advance amount, the digital direct deposit advance risk analysis system 102 will proceed to step 508 and approve the network transaction for the maximum digital direct deposit advance amount. If the digital direct deposit advance risk analysis system 102 identifies that the eligible digital direct deposit advance amount does not exceed the maximum digital direct deposit advance amount, the digital direct deposit advance risk analysis system 102 will proceed to step 510 and approve the network transaction for the eligible digital direct deposit amount. In some cases, rather than approving the network transaction at step 510, the digital direct deposit advance risk analysis system 102 proceeds to step 512.

In one or more embodiments, the digital direct deposit advance risk analysis system 102 identifies or determines if an eligible digital direct deposit advance amount exceeds a maximum pay period advance amount at step 512. In particular, the digital direct deposit advance risk analysis system 102 can compare the eligible digital direct deposit amount to a maximum pay period advance amount to determine an amount to approve for the network transaction. A maximum pay period advance amount can be an amount (e.g., a credit or borrowed amount) for which a user account has accessed or borrowed (e.g., across the inter-network facilitation system). For example, the maximum pay period advance amount can be an aggregated (or summed) amount that comprises multiple amounts borrowed or accessed within a pay period time frame (e.g., two weeks, one month, etc.). In some cases, this can include peer-to-peer transactions, a tenure-based digital direct deposit advance amount, and/or a user account credit limit. If the digital direct deposit advance risk analysis system 102 determines or identifies at step 512 that the eligible digital direct deposit advance amount 504 exceeds a maximum pay period advance amount, then the digital direct deposit advance risk analysis system 102 can proceed to step 514 and deny the network transaction. If the digital direct deposit advance risk analysis system 102 determines or identifies at step 512 that the eligible deposit advance amount 504 does not exceed the maximum pay period advance amount, the digital direct deposit advance risk analysis system 102 proceed to step 516 and approve the network transaction for the eligible digital direct deposit amount.

In one or more embodiments, the digital direct deposit advance risk analysis system 102 can also approve the network transaction for an amount based on the pay period maximum amount. In particular, the digital direct deposit advance risk analysis system 102 can determine to approve the network transaction for a partial amount of the eligible digital direct deposit maximum amount based on a maximum pay period advance amount. To illustrate, if a maximum pay period advance amount is $150 for a user account, but there is already $100 of credit extended, then the digital direct deposit advance risk analysis system 102 may approve the network transaction for a digital direct deposit advance amount of $50.

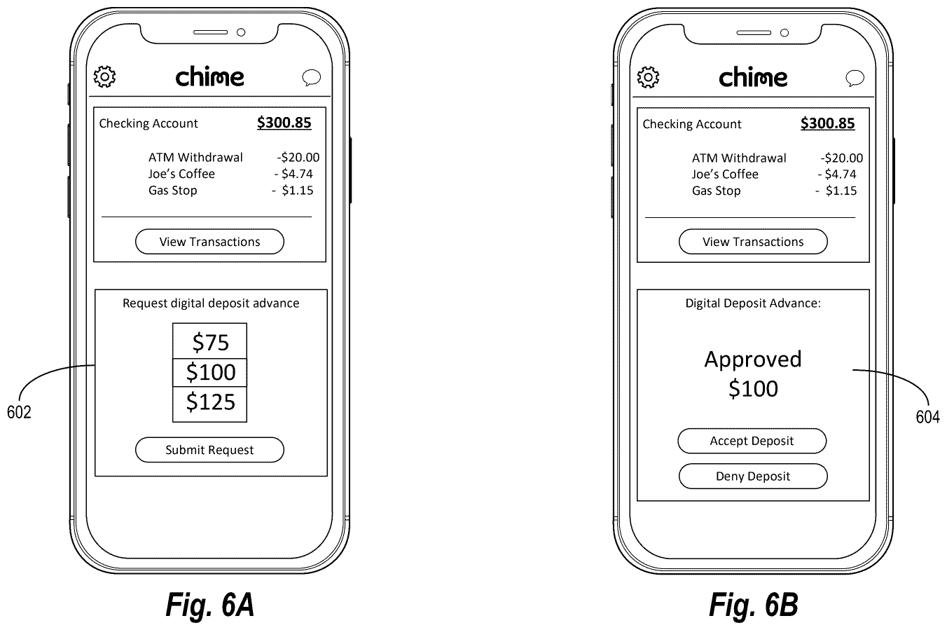

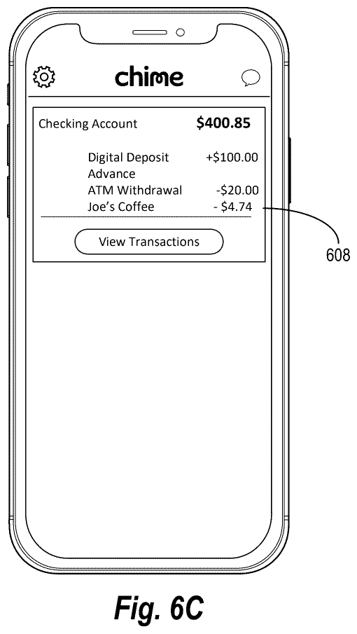

As previously mentioned, in one or more embodiments, the digital direct deposit advance risk analysis system 102 can utilize a digital direct deposit advance interface. In particular, the digital direct deposit advance risk analysis system 102 can use a digital direct deposit advance interface to receive requests and to display information regarding approving and denying network transactions. FIGS. 6A-6C illustrate example graphical user interfaces for initiating a network transaction and displaying information related to processed network transactions in accordance with one or more embodiments. Specifically, FIG. 6A illustrates receiving a request for a network transaction comprising a digital direct deposit advance request, FIG. 6B illustrates displaying an indication of a processed network transaction, and FIG. 6C illustrates displaying a credited digital direct deposit amount.

As shown in FIG. 6A, in one or more embodiments, the digital direct deposit advance risk analysis system 102 can receive, from a client device, a request to initiate a network transaction comprising a digital direct deposit advance request. In particular, the digital direct deposit advance risk analysis system 102 can display, on a client device, digital direct deposit advance interface 602 from which the digital direct deposit advance risk analysis system 102 can receive user inputs of a request for a digital direct deposit advance and a selection of a selectable option for a digital direct deposit advance amount. Though shown as a scroller, the selectable option can be one of many forms of user input, such as an icon, a scroller, or a user input of a specific amount.

In one or more embodiments, the digital direct deposit advance risk analysis system 102 will display an eligible digital direct deposit amount in digital direct deposit advance interface 602. In particular, the digital direct deposit advance risk analysis system 102 can determine an eligible digital direct deposit advance amount associated with the user account and display the amount to the user with a selectable option to initiate the network transaction. For example, the digital direct deposit advance risk analysis system 102 can determine an eligible deposit advance amount based on a risk classification associated with the account (e.g., from features of the user account and previous transactions).

As shown in FIG. 6B, the digital direct deposit advance risk analysis system 102 can display information regarding processing a network transaction in a digital direct deposit interface 604. In particular, the digital direct deposit advance risk analysis system 102 can display whether a network transaction was approved (or not) and a digital direct deposit advance amount. In addition, digital direct deposit interface 604 can comprise a selectable option to accept the digital direct deposit and an option to deny the deposit. For example, the digital direct deposit advance risk analysis system 102 can receive a user selection of the selectable option from the digital direct deposit interface 604 and credit a user account for the digital direct deposit advance amount.

As shown in FIG. 6C, the digital direct deposit advance risk analysis system 102 can display a credit of the digital direct deposit advance to a user account in digital direct deposit interface 608. In particular, the digital direct deposit advance risk analysis system 102 can credit a user account associated with the network transaction for the digital direct deposit amount. For example, based on a user selection of the selectable option to accept the digital direct deposit, the digital direct deposit advance risk analysis system 102 can credit a user account for the selected amount from digital direct deposit advance interface 602 (or another amount as described above in reference to FIG. 5).

As depicted in FIGS. 6A-6B, the digital direct deposit advance risk analysis system 102 allows for digital direct deposit advances with fewer user interface interactions. Indeed, unlike conventional systems that require a user to input information across multiple user interfaces, because the digital direct deposit advance risk analysis system 102 can generate accurate digital direct deposit likelihoods based on relatively few features, the digital direct deposit advance risk analysis system 102 requires fewer interactions. Further, because the digital direct deposit advance risk analysis system 102 can determine a digital direct deposit advance amount before any user interaction, the digital direct deposit advance risk analysis system 102 can provide digital direct deposit advances with only minimal user interface interactions.

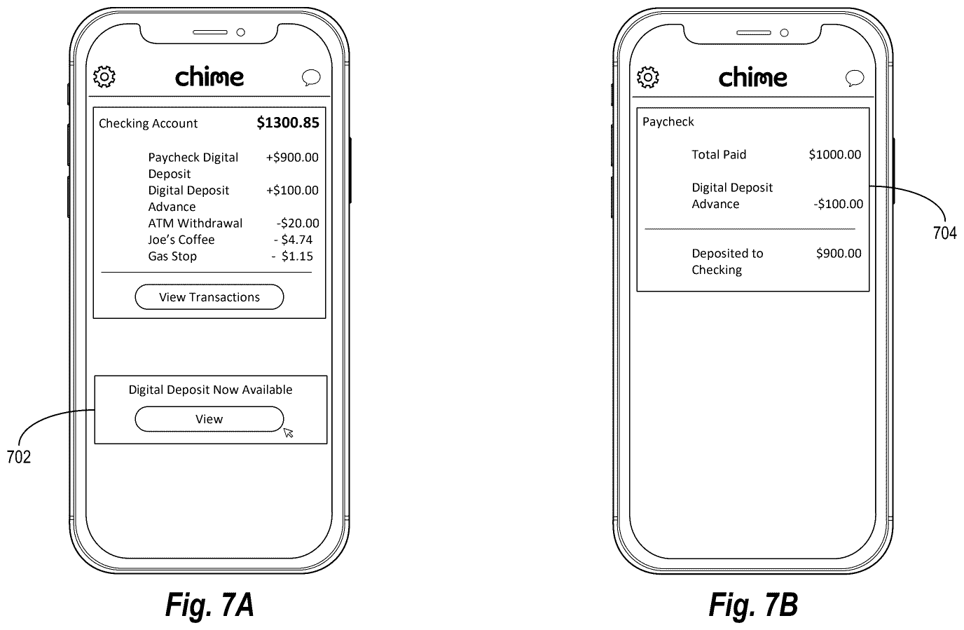

In one or more embodiments, the digital direct deposit advance risk analysis system 102 can reduce the amount of future digital direct deposits based on previous network transactions. In particular, if the digital direct deposit advance risk analysis system 102 identifies that a previous network transaction was approved, the digital direct deposit advance risk analysis system 102 will reduce a future digital direct deposit for the amount of the digital direct deposit advance. FIGS. 7A-7B illustrate example graphical user interfaces for displaying information related to digital direct deposits received after a digital direct deposit advance in accordance with one or more embodiments.

As shown in FIG. 7A, the digital direct deposit advance risk analysis system 102 can identify that a user account received a digital direct deposit. In particular, the digital direct deposit advance risk analysis system 102 can identify that a user account that received a digital direct deposit advance received a future digital direct deposit. For example, after approving a network transaction for a digital direct deposit advance, the digital direct deposit advance risk analysis system 102 will monitor the user account in order to identify when (or if) the user account receives a future digital direct deposit. Upon receiving the future digital direct deposit, the digital direct deposit advance risk analysis system 102 (or the inter-network facilitation system) will credit the account. In some cases, the digital direct deposit advance risk analysis system 102 will determine a credited digital direct deposit amount based on the future digital direct deposit amount and the digital direct deposit advance amount. After receiving the digital direct deposit, the digital direct deposit advance risk analysis system 102 can present a notification that the digital direct deposit is available and a selectable option to view the digital direct deposit in digital direct deposit interface 702.

As shown in FIG. 7B, the digital direct deposit advance risk analysis system 102 can display digital direct deposit information in digital direct deposit interface 704. For example, the digital direct deposit advance risk analysis system 102 can display details about the future digital direct deposit amount (e.g., “total paid”), the digital direct deposit advance amount, and the amount credited or deposited to the user account.

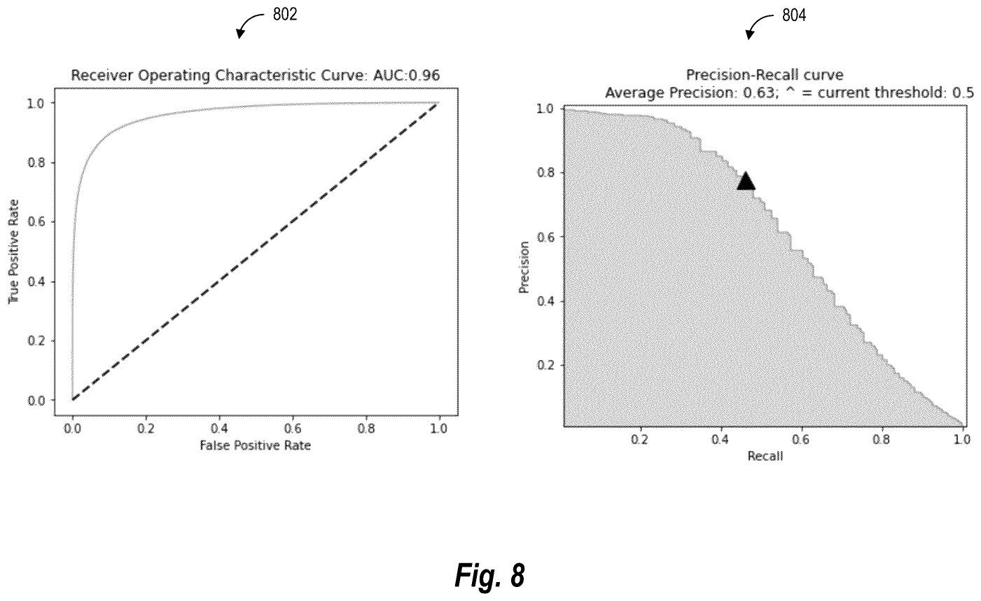

As mentioned, the digital direct deposit advance risk analysis system 102 accurately identifies or predicts whether a user account associated with a network transaction will receive a digital direct deposit. FIG. 8 illustrates a graph depicting the accuracy of the digital direct deposit advance risk analysis system 102 in accordance with one or more embodiments.

As shown in FIG. 8, graph 802 includes a receiver operating characteristic (ROC) curve that illustrates reductions in digital direct deposit likelihood false positives for the digital direct deposit advance risk analysis system 102 as compared to without recalibrating via training dataset by a digital direct deposit predictor machine-learning model when testing for validation. In particular, graph 802 depicts an ROC curve that depicts a true positive rate over a false positive rate with an area under the curve of 1.0. For the ROC curve, the true positive rate represents true-positive network transactions identified by the digital direct deposit predictor machine-learning model divided by the sum of true-positive network transactions and false-positive network transactions identified by the digital direct deposit predictor machine-learning model. By contrast, the false-positive rate represents false-positive network transactions identified by the digital direct deposit predictor machine-learning model divided by the sum of true-positive network transactions and false-positive network transactions identified by the digital direct deposit predictor machine-learning model. As indicated by graph 802, a truncated ROC curve demonstrates a 1.0 area under the curve for the digital direct deposit advance risk analysis system 102 with the digital direct deposit predictor machine-learning model exhibits, thereby demonstrating an improvement in false positive digital direct deposit likelihoods over prior systems.

As also illustrated in FIG. 8, graph 804 includes a binary precision-recall curve that depicts precision over recall when testing for validation. In graph 804, precision represents the number of true-positive network transactions (e.g., where a user account receives a network transaction in a future digital direct deposit timeframe) divided by the sum of true-positive network transactions and false-positive network transactions. By contrast, recall represents the number of true-positive network transactions divided by the sum of true-positive network transactions and false-negative network transactions. As shown, the digital direct deposit advance risk analysis system 102 utilizing the digital direct deposit predictor machine-learning model obtains roughly 0.81 precision, thereby achieving more accurate digital direct deposit likelihoods for network transactions.

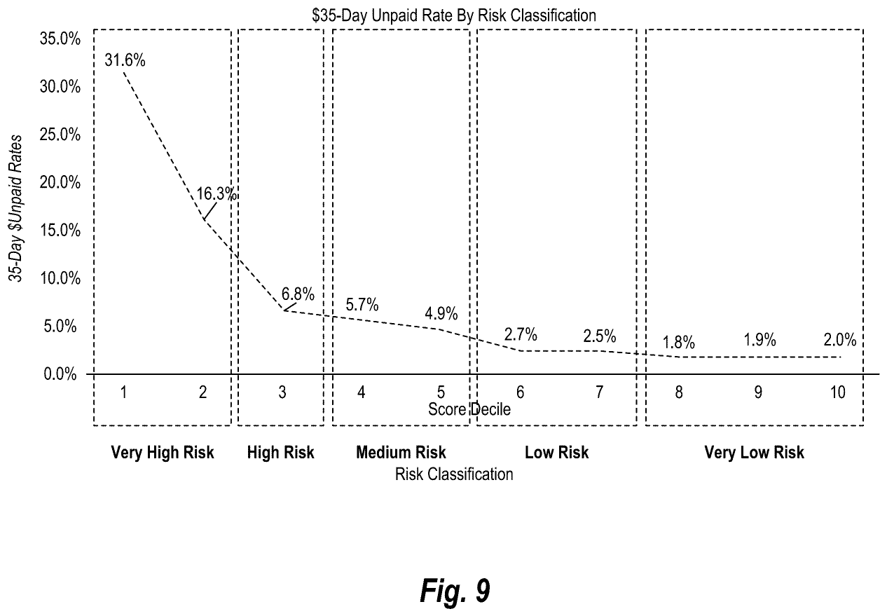

As previously mentioned, the digital direct deposit advance risk analysis system 102 uses a risk classification to process network transactions. FIG. 9 illustrates an example graph depicting accurately labeled network transactions denoting the accuracy of the digital direct deposit advance risk analysis system in accordance with one or more embodiments. Indeed, by utilizing a risk classification, the digital direct deposit advance risk analysis system 102 can accurately identify network transactions in which a user account does not receive a future digital direct deposit, as shown.

FIGS. 1-10, the corresponding text, and the examples provide a number of different methods, systems, devices, and non-transitory computer-readable media of the digital direct deposit advance risk analysis system 102. In addition to the foregoing, one or more embodiments can also be described in terms of flowcharts comprising acts for accomplishing a particular result, as shown in FIG. 11. FIG. 11 may be performed with more or fewer acts. Further, the acts may be performed in differing orders. Additionally, the acts described herein may be repeated or performed in parallel with one another or parallel with different instances of the same or similar acts.

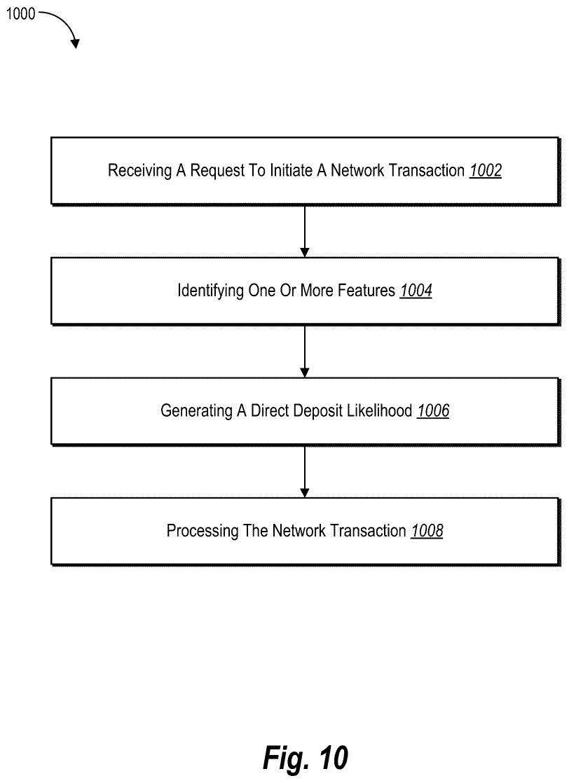

As mentioned, FIG. 10 illustrates a flowchart of a series of acts 1000 for generating a digital direct deposit likelihood and processing a network transaction in accordance with one or more embodiments. While FIG. 10 illustrates acts according to one embodiment, alternative embodiments may omit, add to, reorder, and/or modify any of the acts shown in FIG. 10. The acts of FIG. 10 can be performed as part of a method. Alternatively, a non-transitory computer-readable medium can comprise instructions that, when executed by one or more processors, cause a computing device to perform the acts of FIG. 10. In some embodiments, a system can perform the acts of FIG. 10.

As shown in FIG. 10, the series of acts 1000 includes an act 1002 of receiving a request to initiate a network transaction, an act 1004 of identifying one or more features, an act 1006 of generating a digital direct deposit likelihood, and an act 1008 of processing the network transaction.

In particular, the act 1002 can include receiving a request to initiate a network transaction comprising a digital direct deposit advance request, the act 1004 can include identifying one or more features associated with the network transaction, the act 1006 can include generating, utilizing a digital direct deposit predictor machine-learning model, a digital direct deposit likelihood based on the one or more features of the network transaction, and the act 1008 can include processing the network transaction based on the digital direct deposit likelihood.

For example, in one or more embodiments, the series of acts 1004 includes identifying one or more of: a historical digital direct deposit feature, a user account feature, a check deposit feature, an application activity feature, an account balance feature, a physical card feature, a peer-to-peer transaction feature, a customer service ticket feature, or a time elapsed feature.

In addition, in one or more embodiments, the series of acts 1000 includes identifying user account data associated with the network transaction, based on the digital direct deposit likelihood and the user account data, determining, utilizing a risk analysis assembler, a risk classification for the network transaction, and processing the network transaction according to the risk classification. In one or more embodiments, the series of acts 1000 further includes determining, based on the risk classification, an allowed digital direct deposit advance percent for the network transaction, processing the network transaction by determining a digital direct deposit advance amount for the network transaction based on the allowed digital direct deposit advance percent and an average digital direct deposit amount corresponding to a user account associated with the network transaction, and displaying, in a digital direct deposit advance interface on a client device, an approval notification for the network transaction comprising the digital direct deposit advance amount.

Moreover, in one or more embodiments, the series of acts 1000 includes identifying that the digital direct deposit likelihood indicates that a user account associated with the network transaction will receive a digital direct deposit within a future digital direct deposit timeframe, based on identifying that the digital direct deposit likelihood indicates that a user account associated with the network transaction will receive a digital direct deposit within the future digital direct deposit timeframe, determining a digital direct deposit advance amount for the network transaction, and displaying, in a digital direct deposit advance interface on a client device, an approval notification for the network transaction comprising the digital direct deposit advance amount.

Further, in one or more embodiments, the series of acts 1000 includes generating a training dataset by sampling digital direct deposit training features corresponding to training network transactions comprising digital direct deposit advance requests corresponding to user accounts that received a previous digital direct deposit and training the digital direct deposit predictor machine-learning model utilizing the training dataset.

In addition, in one or more embodiments, the series of acts 1000 includes determining, based on the digital direct deposit likelihood, an eligible digital direct deposit advance amount for the network transaction, determining that the eligible digital direct deposit advance amount for the network transaction exceeds a maximum digital direct deposit advance amount, based on determining that the eligible digital direct deposit advance amount for the network transaction exceeds a maximum digital direct deposit advance amount, approving the network transaction for the maximum digital direct deposit advance amount, and displaying, in a digital direct deposit advance interface on a client device, an approval notification for the network transaction comprising the maximum digital direct deposit advance amount.

Also, in one or more embodiments, the series of acts 1000 includes identifying that the digital direct deposit likelihood indicates that a user account associated with the network transaction will not receive a digital direct deposit within a future digital direct deposit timeframe and, based on identifying that the digital direct deposit likelihood indicates that a user account associated with the network transaction will not receive a digital direct deposit within a future digital direct deposit timeframe, denying the request to initiate the network transaction.

Further, in one or more embodiments, the series of acts includes determining, utilizing a deposit transaction predictor model, a predicted digital direct deposit amount, determining, utilizing a risk analysis assembler and based on the predicted digital direct deposit amount, the digital direct deposit likelihood, and user account data, a risk classification for the network transaction, and based on the risk classification, processing the network transaction.

Additionally, in one or more embodiments, the series of acts 1000 includes determining, based on the digital direct deposit likelihood, an eligible digital direct deposit advance amount for the network transaction, determining that the eligible digital direct deposit advance amount does not exceed a pay period maximum amount, and processing the network transaction by approving the network transaction for the eligible digital direct deposit advance amount.

Moreover, in one or more embodiments, the series of acts 1000 includes identifying that the digital direct deposit likelihood indicates that a user account associated with the network transaction will receive a digital direct deposit paycheck in a future digital direct deposit timeframe, based on identifying that the digital direct deposit likelihood indicates that a user account associated with the network transaction will receive a digital direct deposit paycheck in the future digital direct deposit timeframe, determining an eligible advance amount for the network transaction, and based on determining an eligible advance amount for the network transaction, displaying, in a digital direct deposit advance interface on a client device, an approval notification for the network transaction comprising the eligible advance amount.

Furthermore, in one or more embodiments, the series of acts 1000 includes determining, based on the digital direct deposit likelihood, an eligible digital direct deposit advance amount for the network transaction, determining that the eligible digital direct deposit advance amount for the network transaction exceeds a maximum digital direct deposit advance amount, and approving the network transaction for the maximum digital direct deposit advance amount.

Also, in one or more embodiments, the series of acts 1000 includes identifying that the digital direct deposit likelihood indicates that a user account associated with the network transaction will receive a digital direct deposit paycheck in a future digital direct deposit timeframe, determining, based on identifying that the digital direct deposit likelihood indicated that a user account associated with the network transaction will receive a digital direct deposit paycheck in a future digital direct deposit timeframe, an eligible digital direct deposit advance amount, determining that the eligible digital direct deposit advance amount exceeds a maximum pay period advance amount, and, based on determining that the eligible digital direct deposit advance amount exceeds the maximum pay period advance amount, deny the network transaction.

Moreover, in one or more embodiments, the series of acts 1000 includes identifying user data associated with the network transaction, determining, utilizing a risk analysis assembler and based on the digital direct deposit likelihood and the user data, a risk classification for the network transaction, identifying, based on the risk classification, that the network transaction corresponds to an allowed advance percent of an average digital direct deposit amount, and processing the network transaction by determining a digital direct deposit advance amount for the network transaction based on the allowed advance percent and the average digital direct deposit amount.

Also, in one or more embodiments, the series of acts 1000 includes determining, based on the digital direct deposit likelihood, an eligible digital direct deposit advance amount for the network transaction and that the eligible digital direct deposit advance amount does not exceed a maximum digital direct deposit advance amount, based on determining that the eligible digital direct deposit advance amount does not exceed a maximum digital direct deposit advance amount, processing the network transaction by approving the network transaction for the eligible digital direct deposit advance amount, and based on approving the network transaction, crediting the eligible digital direct deposit advance amount to a user account associated with the network transaction.

Further, in one or more embodiments, the series of acts 1000 includes determining a maximum pay period advance amount based on the digital direct deposit likelihood and one or more of an average digital direct deposit amount, digital direct deposit advance tenure amount, and a user account credit limit, and determining, based on the maximum pay period advance amount, a digital direct deposit advance amount for the network transaction.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed by a general-purpose computer to turn the general-purpose computer into a special purpose computer implementing elements of the disclosure. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. As used herein, the term “cloud computing” refers to a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In addition, as used herein, the term “cloud-computing environment” refers to an environment in which cloud computing is employed.

FIG. 11 illustrates a block diagram of an example computing device 1100 that may be configured to perform one or more of the processes described above. One will appreciate that one or more computing devices, such as the computing device 1100 may represent the computing devices described above (e.g., server(s) 108, and client device 114). In one or more embodiments, the computing device 1100 may be a mobile device (e.g., a mobile telephone, a smartphone, a PDA, a tablet, a laptop, a camera, a tracker, a watch, a wearable device, etc.). In some embodiments, the computing device 1100 may be a non-mobile device (e.g., a desktop computer or another type of client device). Further, the computing device 1100 may be a server device that includes cloud-based processing and storage capabilities.

As shown in FIG. 11, the computing device 1100 can include one or more processor(s) 1102, memory 1104, a storage device 1106, input/output interfaces 1108 (or “I/O interfaces 1108”), and a communication interface 1110, which may be communicatively coupled by way of a communication infrastructure (e.g., bus 1112). While the computing device 1100 is shown in FIG. 10, the components illustrated in FIG. 10 are not intended to be limiting. Additional or alternative components may be used in other embodiments. Furthermore, in certain embodiments, the computing device 1100 includes fewer components than those shown in FIG. 10. Components of the computing device 1100 shown in FIG. 10 will now be described in additional detail.

In particular embodiments, the processor(s) 1102 includes hardware for executing instructions, such as those making up a computer program. As an example, and not by way of limitation, to execute instructions, the processor(s) 1102 may retrieve (or fetch) the instructions from an internal register, an internal cache, memory 1104, or a storage device 1106 and decode and execute them.

The computing device 1100 includes memory 1104, which is coupled to the processor(s) 1102. The memory 1104 may be used for storing data, metadata, and programs for execution by the processor(s). The memory 1104 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1104 may be internal or distributed memory.

The computing device 1100 includes a storage device 1106 includes storage for storing data or instructions. As an example, and not by way of limitation, the storage device 1106 can include a non-transitory storage medium described above. The storage device 1106 may include a hard disk drive (HDD), flash memory, a Universal Serial Bus (USB) drive or a combination these or other storage devices.

As shown, the computing device 1100 includes one or more I/O interfaces 1108, which are provided to allow a user to provide input to (such as user strokes), receive output from, and otherwise transfer data to and from the computing device 1100. These I/O interfaces 1108 may include a mouse, keypad or a keyboard, a touch screen, camera, optical scanner, network interface, modem, other known I/O devices or a combination of such I/O interfaces 1108. The touch screen may be activated with a stylus or a finger.

The I/O interfaces 1108 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1108 are configured to provide graphical data to a display for presentation to a user. The graphical data may be representative of one or more graphical user interfaces and/or any other graphical content as may serve a particular implementation.

The computing device 1100 can further include a communication interface 1110. The communication interface 1110 can include hardware, software, or both. The communication interface 1110 provides one or more interfaces for communication (such as, for example, packet-based communication) between the computing device and one or more other computing devices or one or more networks. As an example, and not by way of limitation, communication interface 1110 may include a network interface controller (NIC) or network adapter for communicating with an Ethernet or other wire-based network or a wireless NIC (WNIC) or wireless adapter for communicating with a wireless network, such as a WI-FI. The computing device 1100 can further include a bus 1112. The bus 1112 can include hardware, software, or both that connects components of computing device 1100 to each other.

FIG. 12 illustrates an example network environment 1200 of the inter-network facilitation system 104. The network environment 1200 includes a client device 1206 (e.g., client device 114), an inter-network facilitation system 104, and a third-party system 1208 connected to each other by a network 1204. Although FIG. 12 illustrates a particular arrangement of the client device 1206, the inter-network facilitation system 104, the third-party system 1208, and the network 1204, this disclosure contemplates any suitable arrangement of client device 1206, the inter-network facilitation system 104, the third-party system 1208, and the network 1204. As an example, and not by way of limitation, two or more of client device 1206, the inter-network facilitation system 104, and the third-party system 1208 communicate directly, bypassing network 1204. As another example, two or more of client device 1206, the inter-network facilitation system 104, and the third-party system 1208 may be physically or logically co-located with each other in whole or in part.

Moreover, although FIG. 12 illustrates a particular number of client devices 1206, inter-network facilitation system 104, third-party systems 1208, and networks 1204, this disclosure contemplates any suitable number of client devices 1206, FIG. 12, third-party systems 1208, and networks 1204. As an example, and not by way of limitation, network environment 1200 may include multiple client devices 1206, inter-network facilitation system 104, third-party systems 1208, and/or networks 1204.

This disclosure contemplates any suitable network 1204. As an example, and not by way of limitation, one or more portions of network 1204 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1204 may include one or more networks 1204.

Links may connect client device 1206, inter-network facilitation system 104 (e.g., which hosts the digital direct deposit advance risk analysis system 102), and third-party system 1208 to network 1204 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1200. One or more first links may differ in one or more respects from one or more second links.

In particular embodiments, the client device 1206 may be an electronic device including hardware, software, or embedded logic components or a combination of two or more such components and capable of carrying out the appropriate functionalities implemented or supported by client device 1206. As an example, and not by way of limitation, a client device 1206 may include any of the computing devices discussed above in relation to FIG. 11. A client device 1206 may enable a network user at the client device 1206 to access network 1204. A client device 1206 may enable its user to communicate with other users at other client devices 1206.

In particular embodiments, the client device 1206 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1206 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1206 one or more Hyper Text Markup Language (“HTML”) files responsive to the HTTP request. The client device 1206 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1204) to link the third-party-system 1208. For example, the inter-network facilitation system 104 may receive authentication credentials from a user to link a third-party system 1208 such as an online bank account, credit account, debit account, or other financial account to a user account within the inter-network facilitation system 104. The inter-network facilitation system 104 can subsequently communicate with the third-party system 1208 to detect or identify balances, transactions, withdrawal, transfers, deposits, credits, debits, or other transaction types associated with the third-party system 1208. The inter-network facilitation system 104 can further provide the aforementioned or other financial information associated with the third-party system 1208 for display via the client device 1206. In some cases, the inter-network facilitation system 104 links more than one third-party system 1208, receiving account information for accounts associated with each respective third-party system 1208 and performing operations or transactions between the different systems via authorized network connections.

In particular embodiments, the inter-network facilitation system 104 may interface between an online banking system and a credit processing system via the network 1204. For example, the inter-network facilitation system 104 can provide access to a bank account of a third-party system 1208 and linked to a user account within the inter-network facilitation system 104. Indeed, the inter-network facilitation system 104 can facilitate access to, and transactions to and from, the bank account of the third-party system 1208 via a client application of the inter-network facilitation system 104 on the client device 1206. The inter-network facilitation system 104 can also communicate with a credit processing system, an ATM system, and/or other financial systems (e.g., via the network 1204) to authorize and process credit charges to a credit account, perform ATM transactions, perform transfers (or other transactions) across accounts of different third-party systems 1208, and to present corresponding information via the client device 1206.

In particular embodiments, the inter-network facilitation system 104 includes a model for approving or denying transactions. For example, the inter-network facilitation system 104 includes a transaction approval machine-learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1208), the inter-network facilitation system 104 can utilize the transaction approval machine-learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1200 either directly or via network 1204. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1206, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1204.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1206. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1206. Information may be pushed to a client device 1206 as notifications, or information may be pulled from client device 1206 responsive to a request received from client device 1206. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1206 associated with users.

In addition, the third-party system 1208 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1204. A third-party system 1208 can communicate with the inter-network facilitation system 104 to provide financial information pertaining to balances, transactions, and other information, whereupon the inter-network facilitation system 104 can provide corresponding information for display via the client device 1206. In particular embodiments, a third-party system 1208 communicates with the inter-network facilitation system 104 to update account balances, transaction histories, credit usage, and other internal information of the inter-network facilitation system 104 and/or the third-party system 1208 based on user interaction with the inter-network facilitation system 104 (e.g., via the client device 1206). Indeed, the inter-network facilitation system 104 can synchronize information across one or more third-party systems 1208 to reflect accurate account information (e.g., balances, transactions, etc.) across one or more networked systems, including instances where a transaction (e.g., a transfer) from one third-party system 1208 affects another third-party system 1208.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a request to initiate a network transaction comprising a digital direct deposit advance request;
identifying one or more features associated with the network transaction;
generating, utilizing a digital direct deposit predictor machine-learning model, a digital direct deposit likelihood based on the one or more features of the network transaction; and
processing the network transaction based on the digital direct deposit likelihood.

2. The computer-implemented method of claim 1, wherein identifying the one or more features associated with the network transaction comprises identifying one or more of: a historical digital direct deposit feature, a user account feature, a check deposit feature, an application activity feature, an account balance feature, a physical card feature, a peer-to-peer transaction feature, a customer service ticket feature, or a time elapsed feature.

3. The computer-implemented method of claim 1, further comprising:
identifying user account data associated with the network transaction;
based on the digital direct deposit likelihood and the user account data, determining, utilizing a risk analysis assembler, a risk classification for the network transaction; and
processing the network transaction according to the risk classification.

4. The computer-implemented method of claim 3, further comprising:
determining, based on the risk classification, an allowed digital direct deposit advance percent for the network transaction;
processing the network transaction by determining a digital direct deposit advance amount for the network transaction based on the allowed digital direct deposit advance percent and an average digital direct deposit amount corresponding to a user account associated with the network transaction; and
displaying, in a digital direct deposit advance interface on a client device, an approval notification for the network transaction comprising the digital direct deposit advance amount.

5. The computer-implemented method of claim 1, wherein processing the network transaction further comprises:
identifying that the digital direct deposit likelihood indicates that a user account associated with the network transaction will receive a digital direct deposit within a future digital direct deposit timeframe;
based on identifying that the digital direct deposit likelihood indicates that a user account associated with the network transaction will receive a digital direct deposit within the future digital direct deposit timeframe, determining a digital direct deposit advance amount for the network transaction; and
displaying, in a digital direct deposit advance interface on a client device, an approval notification for the network transaction comprising the digital direct deposit advance amount.

6. The computer-implemented method of claim 1, further comprising:
generating a training dataset by sampling digital direct deposit training features corresponding to training network transactions comprising digital direct deposit advance requests corresponding to user accounts that received a previous digital direct deposit; and
training the digital direct deposit predictor machine-learning model utilizing the training dataset.

7. The computer-implemented method of claim 1, further comprising:
determining, based on the digital direct deposit likelihood, an eligible digital direct deposit advance amount for the network transaction;
determining that the eligible digital direct deposit advance amount for the network transaction exceeds a maximum digital direct deposit advance amount;
based on determining that the eligible digital direct deposit advance amount for the network transaction exceeds a maximum digital direct deposit advance amount, approving the network transaction for the maximum digital direct deposit advance amount; and
displaying, in a digital direct deposit advance interface on a client device, an approval notification for the network transaction comprising the maximum digital direct deposit advance amount.

8. The computer-implemented method of claim 1, wherein processing the network transaction further comprises:
identifying that the digital direct deposit likelihood indicates that a user account associated with the network transaction will not receive a digital direct deposit within a future digital direct deposit timeframe; and
based on identifying that the digital direct deposit likelihood indicates that a user account associated with the network transaction will not receive a digital direct deposit within a future digital direct deposit timeframe, denying the request to initiate the network transaction.

9. A non-transitory computer-readable medium storing instructions that, when executed by at least one processor, cause a computer system to:
receive a request to initiate a network transaction comprising a digital direct deposit advance request;
identify one or more features associated with the network transaction;
generate, utilizing a digital direct deposit predictor machine-learning model, a digital direct deposit likelihood based on the one or more features of the network transaction; and
process the network transaction based on to the digital direct deposit likelihood.

10. The non-transitory computer-readable medium of claim 9, further comprising instructions that, when executed by the at least one processor, cause the computer system to identify the one or more features associated with the network transaction by identifying one or more of: a historical digital direct deposit feature, a user account feature, a check deposit feature, an application activity feature, a check deposit feature, an account balance feature, a physical card feature, a peer-to-peer transaction feature, a customer service ticket feature, or a time elapsed feature.

11. The non-transitory computer-readable medium of claim 9, further comprising instructions that, when executed by the at least one processor, cause the computer system to:
determine, utilizing a deposit transaction predictor model, a predicted digital direct deposit amount;
determine, utilizing a risk analysis assembler and based on the predicted digital direct deposit amount, the digital direct deposit likelihood, and user account data, a risk classification for the network transaction; and
based on the risk classification, process the network transaction.

12. The non-transitory computer-readable medium of claim 9, further comprising instructions that, when executed by the at least one processor, cause the computer system to:
determine, based on the digital direct deposit likelihood, an eligible digital direct deposit advance amount for the network transaction;
determine that the eligible digital direct deposit advance amount does not exceed a pay period maximum amount; and
process the network transaction by approving the network transaction for the eligible digital direct deposit advance amount.

13. The non-transitory computer-readable medium of claim 9, further comprising instructions that, when executed by the at least one processor, cause the computer system to:
identify that the digital direct deposit likelihood indicates that a user account associated with the network transaction will receive a digital direct deposit paycheck in a future digital direct deposit timeframe;
based on identifying that the digital direct deposit likelihood indicates that a user account associated with the network transaction will receive a digital direct deposit paycheck in the future digital direct deposit timeframe, determine an eligible advance amount for the network transaction; and
based on determining an eligible advance amount for the network transaction, display, in a digital direct deposit advance interface on a client device, an approval notification for the network transaction comprising the eligible advance amount.

14. The non-transitory computer-readable medium of claim 9, further comprising instructions that, when executed by the at least one processor, cause the computer system to:
determine, based on the digital direct deposit likelihood, an eligible digital direct deposit advance amount for the network transaction;
determine that the eligible digital direct deposit advance amount for the network transaction exceeds a maximum digital direct deposit advance amount; and
approve the network transaction for the maximum digital direct deposit advance amount.

15. The non-transitory computer-readable medium of claim 9, further comprising instructions that, when executed by the at least one processor, cause the computer system to:
identify that the digital direct deposit likelihood indicates that a user account associated with the network transaction will receive a digital direct deposit paycheck in a future digital direct deposit timeframe;
determine, based on identifying that the digital direct deposit likelihood indicated that a user account associated with the network transaction will receive a digital direct deposit paycheck in a future digital direct deposit timeframe, an eligible digital direct deposit advance amount;
determine that the eligible digital direct deposit advance amount exceeds a maximum pay period advance amount; and
based on determining that the eligible digital direct deposit advance amount exceeds the maximum pay period advance amount, deny the network transaction.

16. A system comprising:
at least one processor; and
at least one non-transitory computer-readable storage medium storing instructions that, when executed by the at least one processor, cause the system to:
receive a request to initiate a network transaction comprising a digital direct deposit advance request;
identify one or more features associated with the network transaction;
generate, utilizing a digital direct deposit predictor machine-learning model, a digital direct deposit likelihood based on the one or more features of the network transaction; and
based on the digital direct deposit likelihood, process the network transaction.

17. The system of claim 16, further comprising instructions that, when executed by the at least one processor, cause the system to identify the one or more features associated with the network transaction by identifying one or more of: a historical digital direct deposit feature, a user account feature, a check deposit feature, an application activity feature, a check deposit feature, an account balance feature, a physical card feature, a peer-to-peer transaction feature, a customer service ticket feature, or a time elapsed feature.

18. The system of claim 16, further comprising instructions that, when executed by the at least one processor, cause the system to:
identify user data associated with the network transaction;
determine, utilizing a risk analysis assembler and based on the digital direct deposit likelihood and the user data, a risk classification for the network transaction;
identify, based on the risk classification, that the network transaction corresponds to an allowed advance percent of an average digital direct deposit amount; and
process the network transaction by determining a digital direct deposit advance amount for the network transaction based on the allowed advance percent and the average digital direct deposit amount.

19. The system of claim 16, further comprising instructions that, when executed by the at least one processor, cause the system to:
determine, based on the digital direct deposit likelihood, an eligible digital direct deposit advance amount for the network transaction and that the eligible digital direct deposit advance amount does not exceed a maximum digital direct deposit advance amount;
based on determining that the eligible digital direct deposit advance amount does not exceed a maximum digital direct deposit advance amount, process the network transaction by approving the network transaction for the eligible digital direct deposit advance amount; and
based on approving the network transaction, credit the eligible digital direct deposit advance amount to a user account associated with the network transaction.

20. The system of claim 16, further comprising instructions that, when executed by the at least one processor, cause the system to:
determine a maximum pay period advance amount based on the digital direct deposit likelihood and one or more of an average digital direct deposit amount, digital direct deposit advance tenure amount, and a user account credit limit; and
determine, based on the maximum pay period advance amount, a digital direct deposit advance amount for the network transaction.
